(19) United States
(12) Patent Application Publication
(10) Pub. No.: US 2023/0075514 A1
(43) Pub. Date: Mar. 9, 2023

(54) CONCEPT FOR A REPRESENTATION OF NEURAL NETWORK PARAMETERS

(71) Applicant: Fraunhofer-Gesellschaft zur Foerderung der angewandten Forschung e.V., Munich (DE)

(72) Inventors: Simon WIEDEMANN, Berlin (DE); Talmaj MARINC, Berlin (DE); Wojciech SAMEK, Berlin (DE); Paul HAASE, Berlin (DE); Karsten MÜLLER, Berlin (DE); Heiner KIRCHHOFFER, Berlin (DE); Detlev MARPE, Berlin (DE); Heiko SCHWARZ, Berlin (DE); Thomas WIEGAND, Berlin (DE)

(21) Appl. No.: 18/046,406

(22) Filed: Oct. 13, 2022

Related U.S. Application Data
(63) Continuation of application No. PCT/EP2021/059592, filed on Apr. 13, 2021.

(30) Foreign Application Priority Data
Apr. 14, 2020 (EP) 20169502.0

(51) Int. Cl. G06F 17/16; G06F 7/523; G06F 5/01

(52) U.S. Cl. CPC G06F 17/16; G06F 7/523; G06F 5/01

(57) ABSTRACT

Apparatus for generating a NN representation, configured to quantize an NN parameter onto a quantized value by determining a quantization parameter and a quantization value for the NN parameter so that from the quantization parameter, there is derivable a multiplier and a bit shift number. Additionally, the determining of the quantization parameter and the quantization value for the NN parameter is performed so that the quantized value of the NN parameter corresponds to a product between the quantization value and a factor, which depends on the multiplier, bit-shifted by a number of bits which depends on the bit shift number.

### CROSS-REFERENCE TO RELATED APPLICATIONS

This application is a continuation of copending International Application No. PCT/EP2021/059592, filed Apr. 13, 2021, which is incorporated herein by reference in its entirety, and additionally claims priority from European Application No. 20169502.0, filed Apr. 14, 2020, which is also incorporated herein by reference in its entirety.

Embodiments according to the invention related to apparatuses and methods for encoding or decoding neural network parameters using an improved concept for a representation of neural network parameters. An improvement in terms of inference and/or storing bit rate optimization may be achieved.

### BACKGROUND OF THE INVENTION

In their most basic form, neural networks constitute a chain of affine transformations followed by an element-wise non-linear function. They may be represented as a directed acyclic graph, as depicted in FIG. 1. Each node entails a particular value, which is forward propagated into the next node by multiplication with the respective weight value of the edge. All incoming values are then simply aggregated.

FIG. 1 shows an example for a graph representation of a feed forward neural network. Specifically, this 2-layered neural network is a non-linear function which maps a 4-dimensional input vector into the real line.

Mathematically, the neural network of FIG. 1 would calculate the output in the following manner:

output=L₂(L₁(input))

where

Lᵢ(X)=Nᵢ(Bᵢ(X))

and where Bᵢ is the affine transformation of layer i and where Nᵢ is some non-linear function of layer i.

### Biased Layers

In the case of a so-called ‘biased layer’, Bᵢ is a matrix multiplication of weight parameters (edge weights) Wᵢ associated with layer i with the input Xᵢ of layer i followed by a summation with a bias bᵢ:

Bᵢ(X)=Wᵢ*Xᵢ+bᵢ

Wᵢ is a weight matrix with dimensions nᵢ×kᵢ and Xᵢ is the input matrix with dimensions kᵢ×mᵢ. Bias bᵢ is a transposed vectors of length nᵢ. The operator * shall denote matrix multiplication. The summation with bias bᵢ is an element-wise operation on the columns of the matrix. More precisely, Wᵢ*Xᵢ+bᵢ means that bᵢ is added to each column of Wᵢ*Xᵢ.

So-called convolutional layers may also be used by casting them as matrix-matrix products as described in “cuDNN: Efficient Primitives for Deep Learning” (Sharan Chetlur, et al.; arXiv: 1410.0759, 2014).

From now on, we will refer as inference the procedure of calculating the output from a given input. Also, we will call intermediate results as hidden layers or hidden activation values, which constitute a linear transformation+element-wise non-linearity, e.g. such as the calculation of the first dot product+non-linearity above.

Usually, neural networks contain millions of parameters, and may thus need hundreds of MByte for their representation. Consequently, they need high computational resources in order to be executed since their inference procedure involves computations of many dot product operations between large matrices. Hence, it is of high importance to reduce the complexity of performing these dot products.

### Batch-Norm Layers

A more sophisticated variant of affine transformation of a neural network layers comprises a so-called bias- and batch-norm operation as follows:

$$BN ( X ) = \frac{B ( X ) - μ}{\sqrt{{σ}^{2} + ϵ}} \cdot γ + β = \frac{W * X + b - μ}{\sqrt{{σ}^{2} + ϵ}} \cdot γ + β \qquad Equation 1$$

where μ, σ², γ, and β are denoted batch norm parameters. Note that layer indexes i are neglected here. W is a weight matrix with dimensions n×k and X is the input matrix with dimensions k×m. Bias b and batch norm parameters μ, σ², γ, and β are transposed vectors of length n. Operator * denotes a matrix multiplication. Note that all other operations (summation, multiplication, division) on a matrix with a vector are element-wise operations on the columns of the matrix. For example, X·γ means that each column of X is multiplied element-wise with γ. ϵ is a small scalar number (like e.g. 0.001) needed to avoid divisions by 0. However, it may also be 0.

In the case where all vector elements of b equal zero, Equation 1 refers to a batch-norm layer. In contrast, if ϵ and all vector elements of μ and β are set to zero and all elements of γ and σ² are set to 1, a layer without batch norm (bias only) is addressed.

### Efficient Representation of Parameters

The parameters W, b, μ, σ², γ, and β shall collectively be denoted parameters of a layer. They usually need to be signaled in a bitstream. For example, they could be represented as 32 bit floating point numbers or they could be quantized to an integer representation. Note that ϵ is usually not signaled in the bitstream.

A particularly efficient approach for encoding such parameters employs a uniform reconstruction quantizer where each value is represented as integer multiple of a so-called quantization step size value. The corresponding floating point number can be reconstructed by multiplying the integer with the quantization step size, which is usually a single floating point number. However, efficient implementations for neural network inference (that is, calculating the output of the neural network for an input) employ integer operations whenever possible. Therefore, it may be undesirable to need parameters to be reconstructed to a floating point representation.

Therefore, it is desired to improve a concept for a representation of neural network parameters to support an efficient encoding and/or decoding of such parameters. It might be desired to reduce a bit stream into which the neural network parameters are encoded and thus reduce a signalization cost. Additionally, or alternatively, it might be desired to reduce a complexity of computational resources to improve a neural network inference, e.g. it might be desired to achieve an efficient implementation for neural network inference.

### SUMMARY

An embodiment provides an apparatus for generating a NN representation, the apparatus configured to quantize an NN parameter onto a quantized value by determining a quantization parameter and a quantization value for the NN parameter so that from the quantization parameter, there is derivable a multiplier based on a remainder of a division between a dividend derived by the quantization parameter and a divisor derived by an accuracy parameter and a bit shift number based on a rounding of the quotient of the division, so that the quantized value of the NN parameter corresponds to a product between the quantization value and a factor which depends on the multiplier, bit-shifted by a number of bits which depends on the bit shift number.

Another embodiment may have a digital data defining a NN representation, the NN representation including, for representing an NN parameter, a quantization parameter and a quantization value, so that from the quantization parameter, there is derivable a multiplier based on a remainder of a division between a dividend derived by the quantization parameter and a divisor derived by an accuracy parameter and a bit shift number based on a rounding of the quotient of the division, and so that the NN parameter corresponds to a product between the quantization value and a factor which depends on the multiplier, bit-shifted by a number of bits which depends on the bit shift number.

Another embodiment may have an apparatus for deriving a NN parameter from a NN representation, configured to derive a quantization parameter from the NN representation, derive a quantization value from the NN representation, and derive, from the quantization parameter, a multiplier based on a remainder of a division between a dividend derived by the quantization parameter and a divisor derived by an accuracy parameter and a bit shift number based on a rounding of the quotient of the division, wherein the NN parameter corresponds to a product between the quantization value and a factor which depends on the multiplier, bit-shifted by a number of bits which depends on the bit shift number.

Another embodiment may have a device for performing an inference using a NN, the device configured to compute an inference output based on a NN input using the NN, wherein the NN includes a pair of NN layers and inter-neuron activation feed-forwards from a first of the pair of NN layers to a second of the NN layers, and the device is configured to compute activations of the neural network neurons of the second NN layers based on activations of the neural network neurons of the first NN layers by forming a matrix X out of the activations of the neural network neurons of the first NN layers, and computing s·W′*X wherein * denotes a matrix multiplication, W′ is a weight matrix of dimensions n×m with n and m∈ [symbol] , s is transposed vector of length n, and · denotes a column wise Hadamard multiplication between a matrix on the one side of · and a transposed vector on the other side.

Another embodiment may have a method for generating a NN representation, including quantizing an NN parameter onto a quantized value by determining a quantization parameter and a quantization value for the NN parameter so that from the quantization parameter, there is derivable a multiplier based on a remainder of a division between a dividend derived by the quantization parameter and a divisor derived by an accuracy parameter and a bit shift number based on a rounding of the quotient of the division, so that the quantized value of the NN parameter corresponds to a product between the quantization value and a factor which depends on the multiplier, bit-shifted by a number of bits which depends on the bit shift number.

According to another embodiment, a method for deriving a NN parameter from a NN representation may have the steps of: deriving a quantization parameter from the NN representation, deriving a quantization value from the NN representation, and deriving, from the quantization parameter, a multiplier based on a remainder of a division between a dividend derived by the quantization parameter and a divisor derived by a accuracy parameter and a bit shift number based on a rounding of the quotient of the division, wherein the NN parameter corresponds to a product between the quantization value and a factor which depends on the multiplier, bit-shifted by a number of bits which depends on the bit shift number.

Another embodiment may have a method for performing an inference using a NN, having the steps of: computing an inference output based on a NN input using the NN, wherein the NN comprises a pair of NN layers and inter-neuron activation feed-forwards from a first of the pair of NN layers to a second of the NN layers, and computing activations of the neural network neurons of the second NN layers based on activations of the neural network neurons of the first NN layers by forming a matrix X out of the activations of the neural network neurons of the first NN layers, and computing s·W′*X wherein * denotes a matrix multiplication, W′ is a weight matrix of dimensions n×m with n and m∈ [symbol] , s is transposed vector of length n, and · denotes a column wise Hadamard multiplication between a matrix the one side of · and a transposed vector on the other side ·.

Another embodiment may have a digital storage medium including inventive digital data.

Another embodiment may have a computer program for implementing the inventive method.

Another embodiment may have a data stream generated by an inventive apparatus.

In accordance with a first aspect of the present invention, the inventors of the present application realized that one problem encountered with neural network (NN) representations stems from the fact that neural networks contain millions of parameters, and may thus need hundreds of MByte for their representation. Consequently, they need high computational resources in order to be executed since their inference procedure involves computations of many dot product operations between large matrices. According to the first aspect of the present application, this difficulty is overcome by using a quantization of a NN parameter that allow for an inference with only few or even no floating point operations at all. The inventors found, that it is advantageous to determine a quantization parameter based on which a multiplier and a bit shift number can be derived. This is based on the idea that it is efficient in terms of bit rate to signal only the quantization parameter and a quantization value instead of a 32 bit floating point value. The quantized value of the NN parameter can be calculated using the multiplier, the bit shift number and the quantization value, for which reason it is possible to carry out computations, e.g. a summation of NN parameters and/or a multiplication of a NN parameter with a vector, in integer domain instead of floating point domain. Therefore, with the presented NN representation an efficient computation of an inference can be achieved.

Accordingly, in accordance with a first aspect of the present application, an apparatus for generating a NN representation, e.g. a data stream, is configured to quantize an NN parameter onto a quantized value by determining a quantization parameter and a quantization value for the NN parameter so that from the quantization parameter, there is derivable a multiplier and a bit shift number. The generated NN representation can be read/decoded by an apparatus for deriving a NN parameter, e.g. the quantized value of the NN parameter, from the NN representation, e.g. the data stream. The apparatus for deriving the NN parameter is configured to derive the quantization parameter and the quantization value from the NN representation, and derive, from the quantization parameter, the multiplier and the bit shift number. The multiplier is derivable from the quantization parameter based on a remainder of a division between a dividend derived by the quantization parameter and a divisor derived by an accuracy parameter, e.g., the accuracy parameter may be set to a default value or several different integer values for the accuracy parameter such as natural numbers or powers of two may be tested by the apparatus for the whole NN or for each section of the NN such as each layer and the best in terms of quantization error and bit rate such as in terms of a Langrange sum of the same so as to take the best value as the accuracy parameter and signal this selection in the NN representation. The bit shift number is derivable from the quantization parameter based on a rounding of the quotient of the division. The NN parameter, in case of the apparatus for deriving the NN parameter, or the quantized value of the NN parameter, in case of the apparatus for generating the NN representation, corresponds to (e.g. at least in terms of the quantized value's absolute value with a separate treatment of the sign in case of the shift, or even in terms of both absolute value and sign such as in case of using the two's complement representation and two's complement arithmetic respectively, for the product, its factors and the shift) a product between the quantization value and a factor which depends on the multiplier, bit-shifted by a number of bits which depends on the bit shift number. Digital data can define the NN representation comprising, for representing the NN parameter, the quantization parameter and the quantization value, as described above.

It is to be noted that the NN parameter derived by the apparatus for deriving the NN parameter corresponds to the quantized value of the NN parameter, which value is generated by the apparatus for generating the NN representation. This is due to the fact, that the apparatus for deriving the NN parameter does never see the original NN parameter, for which reason the quantized value of the NN parameter is regarded as the NN parameter in view of the apparatus for deriving the NN parameter.

An embodiment is related to a device for performing an inference using a NN, the device comprising a NN parametrizer configured to parametrize the NN. The NN parametrizer comprises an apparatus for deriving a NN parameter from a NN representation, as described above. Additionally, the device comprises a computation unit configured to compute an inference output based on a NN input using the NN. As described above, the NN parameter can be derived based on the multiplier, the bit shift number and the quantization value, for which reason it is possible to carry out computations, e.g. a summation of NN parameters and/or a multiplication of a NN parameter with a vector, in integer domain instead of floating point domain. Therefore, an efficient computation of the inference can be achieved by the device.

In accordance with a second aspect of the present invention, the inventors of the present application realized that one problem encountered when performing an inference using a neural network (NN) stems from the fact that a weight matrix used for the inference might have a quantization error, for which reason, only a low level of accuracy is achieved. According to the first aspect of the present application, this difficulty is overcome by using a transposed vector s, e.g. a scaling factor, multiplied element-wise with each column of a weight matrix W′. The inventors found, that arithmetic coding methods yield higher coding gain by using the scaling of the weight matrix and/or that the scaling of the weight matrix increases the neural network performance results, e.g. achieve higher accuracy. This is based on the idea that the transposed vector s can be adapted efficiently, e.g. in dependence on the weight matrix, e.g. a quantized weight matrix, in order to reduce the quantization error and as such increasing the prediction performance of a quantized neural network. Furthermore, the inventors found that a representation efficiency can be increased by factoring a weight parameter as a composition of the transposed vector s and the weight matrix W′, since it allows to quantize both independently, e.g. different quantization parameters can be used for a quantization of the transposed vector s and the weight matrix W′. This is beneficial from a performance point of view, but also from a hardware efficiency perspective.

Accordingly, in accordance with a second aspect of the present application, a device for performing an inference using a NN, is configured to compute an inference output based on a NN input using the NN. The NN comprises a pair of NN layers and inter-neuron activation feed-forwards from a first of the pair of NN layers to a second of the NN layers. The device is configured to compute activations of the neural network neurons of the second NN layers based on activations of the neural network neurons of the first NN layers by forming a matrix X out of the activations of the neural network neurons of the first NN layers, and computing s·W′*X. The operator * denotes a matrix multiplication, W′ is a weight matrix of dimensions n×m with n and m∈ [symbol] s is a transposed vector of length n, and the operator · denotes a column wise Hadamard multiplication between a matrix on the one side of · and a transposed vector on the other side of ·.

In accordance with a third aspect of the present invention, the inventors of the present application realized that one problem encountered when using Batch-norm layers stems from the fact that batch-norm parameters/elements of a batch-norm operator are usually in a floating point representation. However, efficient implementations for neural network inference (that is, calculating the output of the neural network for an input) employ integer operations whenever possible. This difficulty is overcome by assigning a predefined constant value to batch-norm parameters/elements, e.g. to b and μ and σ² or σ. The inventors found, that the batch-norm parameters/elements can be compressed much more efficiently, if they have a predefined constant value. This is based on the idea that this enables the usage of a single flag indicating whether all elements/parameters have a predefined constant value, so that they can be set to the predefined constant value. Additionally, it was found that a result of the batch norm operator is not changed by using predefined constant values.

Accordingly, in accordance with a third aspect of the present application, a first embodiment is related to an apparatus for coding NN parameters of a batch norm operator of a NN into an NN representation. The batch norm operator is defined as

$$\frac{W * X + b - μ}{\sqrt{{σ}^{2} + ϵ}} \cdot γ + β$$

wherein
μ, σ², γ, and β are batch norm parameters, e.g. transposed vectors comprising one component for each output node,
W is a weight matrix, e.g. each row of which is for one output node, with each component of the respective row being associated with one row of X,
X is an input matrix derived from activations of a NN layer,
b is a transposed vector forming a bias, e.g. transposed vector comprising one component for each output node,
ϵ is a constant for division-by-zero avoidance,
· denotes a column wise Hadamard multiplication between a matrix on the one side of · and a transposed vector on the other side, and
* denotes a matrix multiplication.

The apparatus is configured to receive b and μ and γ and β and σ² or σ and compute

$${β}^{′} := β + \frac{( b - μ ) * γ}{\sqrt{{σ}^{2} + ϵ}} and {γ}^{′} := γ \cdot \frac{\sqrt{θ + ϵ}}{\sqrt{{σ}^{2} + ϵ}}$$

Additionally, the apparatus is configured to code into the NN representation β′ and γ′, e.g. so that same are also transposed vectors comprising one component for each output node, as NN parameters of the batch norm operator so as to define the batch norm operator as

$$\frac{W * X + {b}^{′} - {μ}^{′}}{\sqrt{{σ}^{′2} + ϵ}} \cdot {γ}^{′} + {β}^{′}$$

with
σ′²:=θ, μ′:=0, b′:=0, wherein θ is a predetermined parameter.

A parallel apparatus for decoding NN parameters of a batch norm operator of a NN from a NN representation is configured to derive γ, and β from the NN representation and infer, or derive by way of one signaling applying to all components thereof, that σ′²:=θ and μ′:=0 and b′:=0, wherein θ is a predetermined parameter. The apparatus is, e.g., configured to read the one signaling, e.g. a flag, and infer or derive therefrom that σ′²:=θ and μ′:=0 and b′:=0. The batch-norm operator is defined, as described above with regard to the first embodiment of the third aspect.

Accordingly, in accordance with a third aspect of the present application, a second embodiment is related to an apparatus for coding NN parameters of a batch norm operator of a NN into an NN representation. The batch norm operator is defined as

$$\frac{W * X + b - μ}{\sqrt{{σ}^{2}}} \cdot γ + β$$

wherein
μ, σ², γ, and β are batch norm parameters, e.g. transposed vectors comprising one component for each output node,
W is a weight matrix, e.g. each row of which is for one output node, with each component of the respective row being associated with one row of X,
X is an input matrix derived from activations of a NN layer,
b is a transposed vector forming a bias, e.g. transposed vector comprising one component for each output node,
· denotes a column wise Hadamard multiplication between a matrix on the one side of · and a transposed vector on the other side, and
* denotes a matrix multiplication.

The apparatus is configured to receive b and μ and γ and β and σ² or a and compute

$${β}^{′} := β + \frac{( b - μ ) * γ}{\sqrt{{σ}^{2}}} and {γ}^{′} := γ \cdot \frac{1}{\sqrt{{σ}^{2}}}$$

Additionally, the apparatus is configured to code into the NN representation β′ and γ′ as NN parameters of the batch norm operator so as to define the batch norm operator as

$$\frac{W * X + {b}^{′} - {μ}^{′}}{\sqrt{{σ}^{′2}}} \cdot {γ}^{′} + {β}^{′}$$

with
σ′²:=1, μ′:=0 and b′:=0.

A parallel apparatus for decoding NN parameters of a batch norm operator of a NN from an NN representation is configured to derive γ and β from the NN representation, and infer, or derive by way of one signaling applying to all components thereof, that σ²:=1 and μ:=0 and b:=0. The apparatus is, e.g., configured to read the one signaling, e.g. a flag, and infer or derive therefrom that σ²:=1 and μ:=0 and b:=0. The batch-norm operator is defined, as described above with regard to the second embodiment of the third aspect.

Accordingly, in accordance with a third aspect of the present application, a third embodiment is related to an apparatus for coding NN parameters of a batch norm operator of a NN into an NN representation. The batch norm operator is defined as

$$\frac{W * X - μ}{\sqrt{{σ}^{2} + ϵ}} \cdot γ + β$$

wherein
μ, σ², γ, and β are batch norm parameters, e.g. transposed vectors comprising one component for each output node,
W is a weight matrix, e.g. each row of which is for one output node, with each component of the respective row being associated with one row of X,
X is an input matrix derived from activations of a NN layer,
ϵ is a constant for division-by-zero avoidance,
· denotes a column wise Hadamard multiplication between a matrix on the one side of · and a transposed vector on the other side, and
* denotes a matrix multiplication.

The apparatus is configured to receive μ and γ and β and σ² or σ and compute

$${β}^{′} := β - \frac{μ * γ}{\sqrt{{σ}^{2} + ϵ}} and {γ}^{′} := γ \cdot \frac{\sqrt{θ + ϵ}}{\sqrt{{σ}^{2} + ϵ}}$$

Additionally, the apparatus is configured to code into the NN representation β′ and γ′ as NN parameters of the batch norm operator so as to define the batch norm operator as

$$\frac{W * X - {μ}^{′}}{\sqrt{{σ}^{′2} + ϵ}} \cdot {γ}^{′} + {β}^{′}$$

with
σ′²:=θ and μ′:=0, wherein θ is a predetermined parameter.

A parallel apparatus for decoding NN parameters of a batch norm operator of a NN from a NN representation is configured to derive γ and β from the NN representation, and infer, or derive by way of one signaling applying to all components thereof, that σ²:=θ and μ:=0, wherein θ is a predetermined parameter. The apparatus is, e.g., configured to read the one signaling, e.g. a flag, and infer or derive therefrom that σ²:=θ and μ:=0. The batch-norm operator is defined, as described above with regard to the third embodiment of the third aspect.

Accordingly, in accordance with a third aspect of the present application, a fourth embodiment is related to an apparatus for coding NN parameters of a batch norm operator of a NN into an NN representation. The batch norm operator is defined as

$$\frac{W * X - μ}{\sqrt{{σ}^{2}}} \cdot γ + β$$

wherein
μ, σ², γ, and β are batch norm parameters, e.g. transposed vectors comprising one component for each output node,
W is a weight matrix, e.g. each row of which is for one output node, with each component of the respective row being associated with one row of X,
X is an input matrix derived from activations of a NN layer,
· denotes a column wise Hadamard multiplication between a matrix the one side of · and a transposed vector on the other side, and
* denotes a matrix multiplication.

The apparatus is configured to receive μ and γ and β and σ² or σ and compute

$${β}^{′} := β - \frac{μ * γ}{\sqrt{{σ}^{2}}} and {γ}^{′} := γ \cdot \frac{1}{\sqrt{{σ}^{2}}}$$

Additionally, the apparatus is configured to code into the NN representation β′ and γ′ as NN parameters of the batch norm operator so as to define the batch norm operator as

$$\frac{W * X - {μ}^{′}}{\sqrt{{σ}^{′2}}} \cdot {γ}^{′} + {β}^{′}$$

with
σ′²:=1 and μ′:=0.

A parallel apparatus for decoding NN parameters of a batch norm operator of a NN from an NN representation is configured to derive γ and β from the NN representation and infer, or derive by way of one signaling applying to all components thereof, that σ²:=1 and μ:=0. The apparatus is, e.g., configured to read the one signaling, e.g. a flag, and infer or derive therefrom that σ²:=1 and μ:=0. The batch-norm operator is defined, as described above with regard to the fourth embodiment of the third aspect.

The following methods operate according to the principles described above:

An embodiment is related to a method for generating a NN representation, comprising quantizing a NN parameter onto a quantized value by determining a quantization parameter and a quantization value for the NN parameter so that from the quantization parameter, there is derivable a multiplier based on a remainder of a division between a dividend derived by the quantization parameter and a divisor derived by an accuracy parameter and so that from the quantization parameter, there is derivable a bit shift number based on a rounding of the quotient of the division. The quantization parameter is determined so that the quantized value of the NN parameter corresponds to a product between the quantization value and a factor which depends on the multiplier, bit-shifted by a number of bits which depends on the bit shift number.

An embodiment is related to a method for deriving a NN parameter from a NN representation, comprising deriving a quantization parameter and a quantization value from the NN representation. Additionally, the method comprises deriving, from the quantization parameter, a multiplier based on a remainder of a division between a dividend derived by the quantization parameter and a divisor derived by a accuracy parameter and deriving, from the quantization parameter, a bit shift number based on a rounding of the quotient of the division. The NN parameter corresponds to a product between the quantization value and a factor which depends on the multiplier, bit-shifted by a number of bits which depends on the bit shift number.

An embodiment is related to a method for performing an inference using a NN, comprising parametrizing the NN, using for deriving a NN parameter from a NN representation the above described method for deriving a NN parameter. Additionally, the method for performing the inference comprises computing an inference output based on a NN input using the NN.

An embodiment is related to a method for performing an inference using a NN, comprising computing an inference output based on a NN input using the NN. The NN comprises a pair of NN layers and inter-neuron activation feed-forwards from a first of the pair of NN layers to a second of the NN layers. The method comprises computing activations of the neural network neurons of the second NN layers based on activations of the neural network neurons of the first NN layers by forming a matrix X out of the activations of the neural network neurons of the first NN layers, and by computing s·W′*X wherein * denotes a matrix multiplication, W′ is a weight matrix of dimensions n×m with n and m∈ [symbol] , s is transposed vector of length n, and · denotes a column wise Hadamard multiplication between a matrix the one side of · and a transposed vector on the other side ·.

An embodiment is related to a method for coding NN parameters of a batch norm operator of a NN into an NN representation, the batch norm operator being defined as

$$\frac{W * X + b - μ}{\sqrt{{σ}^{2} + ϵ}} \cdot γ + β ,$$

wherein μ, σ², γ, and β are batch norm parameters, W is a weight matrix, X is an input matrix derived from activations of a NN layer, b is a transposed vector forming a bias, ϵ is a constant for division-by-zero avoidance, · denotes a column wise Hadamard multiplication between a matrix the one side of · and a transposed vector on the other side, and * denotes a matrix multiplication. The method comprises receiving b, μ, γ, β and σ² or σ and computing

$${β}^{′} := β + \frac{( b - μ ) * γ}{\sqrt{{σ}^{2} + ϵ}} and {γ}^{′} := γ \cdot \frac{\sqrt{θ + ϵ}}{\sqrt{{σ}^{2} + ϵ}} .$$

Additionally, the method comprises coding into the NN representation β′ and γ′ as NN parameters of the batch norm operator so as to define the batch norm operator as

$$\frac{W * X + {b}^{′} - {μ}^{′}}{\sqrt{{σ}^{′2} + ϵ}} \cdot {γ}^{′} + {β}^{′}$$

with σ′²:=θ, μ′:=0 and b′:=0, wherein θ is a predetermined parameter.

An embodiment is related to a method for coding NN parameters of a batch norm operator of a NN into an NN representation, the batch norm operator being defined as

$$\frac{W * X + b - μ}{\sqrt{{σ}^{2}}} \cdot γ + β ,$$

wherein μ, σ², γ, and β are batch norm parameters, W is a weight matrix, X is an input matrix derived from activations of a NN layer, b is a transposed vector forming a bias, · denotes a column wise Hadamard multiplication between a matrix the one side of · and a transposed vector on the other side, and * denotes a matrix multiplication. The method comprises receiving b, μ, γ, β and σ² or σ and computing

$${β}^{′} := β + \frac{( b - μ ) * γ}{\sqrt{{σ}^{2}}} and {γ}^{′} := γ \cdot \frac{1}{\sqrt{{σ}^{2}}} .$$

Additionally, the method comprises coding into the NN representation β′ and γ′ as NN parameters of the batch norm operator so as to define the batch norm operator as

$$\frac{W * X + {b}^{′} - {μ}^{′}}{\sqrt{{σ}^{′2}}} \cdot {γ}^{′} + {β}^{′}$$

with σ′²:=1, μ′:=0 and b′:=0.

An embodiment is related to a method for coding NN parameters of a batch norm operator of a NN into an NN representation, the batch norm operator being defined as

$$\frac{W * X - μ}{\sqrt{{σ}^{2} + ϵ}} \cdot γ + β ,$$

wherein μ, σ², γ, and β are batch norm parameters, W is a weight matrix, X is an input matrix derived from activations of a NN layer, ϵ is a constant for division-by-zero avoidance, · denotes a column wise Hadamard multiplication between a matrix the one side of · and a transposed vector on the other side, and * denotes a matrix multiplication. The method comprises receiving μ, γ, β and σ² or σ and computing

$${β}^{′} := β - \frac{μ * γ}{\sqrt{{σ}^{2} + ϵ}} and {γ}^{′} := γ \cdot \frac{\sqrt{θ + ϵ}}{\sqrt{{σ}^{2} + ϵ}} .$$

Additionally, the method comprises coding into the NN representation β′ and γ′ as NN parameters of the batch norm operator so as to define the batch norm operator as

$$\frac{W * X - μ ′}{\sqrt{{σ}^{{′}_{2}} + ϵ}} \cdot {γ}^{′} + {β}^{′}$$

with σ′²:=θ and μ′:=0, wherein θ is a predetermined parameter.

An embodiment is related to a method for coding NN parameters of a batch norm operator of a NN into an NN representation, the batch norm operator being defined as

$$\frac{W * X - μ}{\sqrt{{σ}^{2}}} \cdot γ + β ,$$

wherein μ, σ², γ, and β are batch norm parameters, W is a weight matrix, X is an input matrix derived from activations of a NN layer, · denotes a column wise Hadamard multiplication between a matrix the one side of · and a transposed vector on the other side, and * denotes a matrix multiplication. The method comprises receiving μ, γ, β and σ² or σ and computing

$${β}^{′} := β - \frac{μ * γ}{\sqrt{{σ}^{2}}} and {γ}^{′} := γ \cdot \frac{1}{\sqrt{{σ}^{2}}} .$$

Additionally, the method comprises coding into the NN representation β′ and γ′ as NN parameters of the batch norm operator so as to define the batch norm operator as

$$\frac{W * X - μ ′}{\sqrt{{σ}^{{′}_{2}}}} \cdot {γ}^{′} + {β}^{′}$$

with σ′²:=1 and μ′:=0.

An embodiment is related to a method for decoding NN parameters of a batch norm operator of a NN from an NN representation, the batch norm operator being defined as

$$\frac{W * X + b - μ}{\sqrt{{σ}^{2} + ϵ}} \cdot γ + β ,$$

wherein μ, σ², γ, and β are batch norm parameters, W is a weight matrix, X is an input matrix derived from activations of a NN layer, b is a transposed vector forming a bias, ϵ is a constant for division-by-zero avoidance, · denotes a column wise Hadamard multiplication between a matrix the one side of · and a transposed vector on the other side, and denotes a matrix multiplication. The method comprises deriving γ, and β from the NN representation and inferring, or deriving by way of one signaling applying to all components thereof, that σ′²:=θ, μ′:=0 and b′:=0, wherein θ is a predetermined parameter.

An embodiment is related to a method for decoding NN parameters of a batch norm operator of a NN from an NN representation, the batch norm operator being defined as

$$\frac{W * X + b - μ}{\sqrt{{σ}^{2}}} \cdot γ + β ,$$

wherein μ, σ², γ, and β are batch norm parameters, W is a weight matrix, X is an input matrix derived from activations of a NN layer, b is a transposed vector forming a bias, · denotes a column wise Hadamard multiplication between a matrix the one side of · and a transposed vector on the other side, and * denotes a matrix multiplication. The method comprises deriving γ, and β from the NN representation, and inferring, or deriving by way of one signaling applying to all components thereof, that σ²:=1, μ:=0 and b:=0.

An embodiment is related to a method for decoding NN parameters of a batch norm operator of a NN from an NN representation, the batch norm operator being define as

$$\frac{W * X - μ}{\sqrt{{σ}^{2} + ϵ}} \cdot γ + β ,$$

wherein μ, σ², γ, and β are batch norm parameters, W is a weight matrix, X is an input matrix derived from activations of a NN layer, E is a constant for division-by-zero avoidance, · denotes a column wise Hadamard multiplication between a matrix the one side of · and a transposed vector on the other side, and * denotes a matrix multiplication. The method comprises deriving γ, and β from the NN representation, and inferring, or deriving by way of one signaling applying to all components thereof, that σ²:=θ and μ:=0, wherein θ is a predetermined parameter.

An embodiment is related to a method for decoding NN parameters of a batch norm operator of a NN from an NN representation, the batch norm operator being defined as

$$\frac{W * X - μ}{\sqrt{{σ}^{2}}} \cdot γ + β ,$$

wherein μ, σ², γ, and β are batch norm parameters, W is a weight matrix, X is an input matrix derived from activations of a NN layer, · denotes a column wise Hadamard multiplication between a matrix the one side of · and a transposed vector on the other side, and * denotes a matrix multiplication. The method comprises deriving γ, and β from the NN representation and inferring, or deriving by way of one signaling applying to all components thereof, that σ²:=1 and μ:=0.

The methods, as described above, are based on the same considerations as the above-described apparatuses or devices. The methods can, by the way, be completed with all features and functionalities, which are also described with regard to the apparatuses or devices.

An embodiment is related to a digital storage medium comprising digital data defining a NN representation generated by a method or apparatus for generating a NN representation, as described above.

An embodiment is related to a computer program for implementing one of the methods described above.

An embodiment is related to a data stream generated by a method or apparatus for generating a NN representation, as described above.

### BRIEF DESCRIPTION OF THE DRAWINGS

Embodiments of the present invention will be detailed subsequently referring to the appended drawings, in which:

FIG. 1 shows a neural network;

FIG. 2 shows schematically an apparatus for generating a NN representation, digital data defining the NN representation and an apparatus for deriving a NN parameter from the NN representation, according to an embodiment of the invention;

FIG. 3 shows schematically a feed-forward neural network;

FIG. 4 shows schematically a device for performing an inference using a NN parametrizer, according to an embodiment of the invention;

FIG. 5 shows schematically a device for performing an inference by factoring a weight parameter as a composition of a vector and a matrix, according to an embodiment of the invention;

FIG. 6 shows schematically an apparatus for coding NN parameters into a NN representation and an apparatus for decoding NN parameters from a NN representation, according to an embodiment of the invention; and

FIG. 7 shows schematically possible relationships between the matrices X and W.

### DETAILED DESCRIPTION OF THE INVENTION

Equal or equivalent elements or elements with equal or equivalent functionality are denoted in the following description by equal or equivalent reference numerals even if occurring in different figures.

In the following description, a plurality of details is set forth to provide a more throughout explanation of embodiments of the present invention. However, it will be apparent to those skilled in the art that embodiments of the present invention may be practiced without these specific details. In other instances, well-known structures and devices are shown in block diagram form rather than in detail in order to avoid obscuring embodiments of the present invention. In addition, features of the different embodiments described herein after may be combined with each other, unless specifically noted otherwise.

In the following, an efficient approach for representing and signaling quantization step sizes of parameters of a layer that allow for an inference with only few or even no floating point operations at all is presented. That is, the representation is efficient in terms of bit rate and may further be used for an efficient computation of the inference.

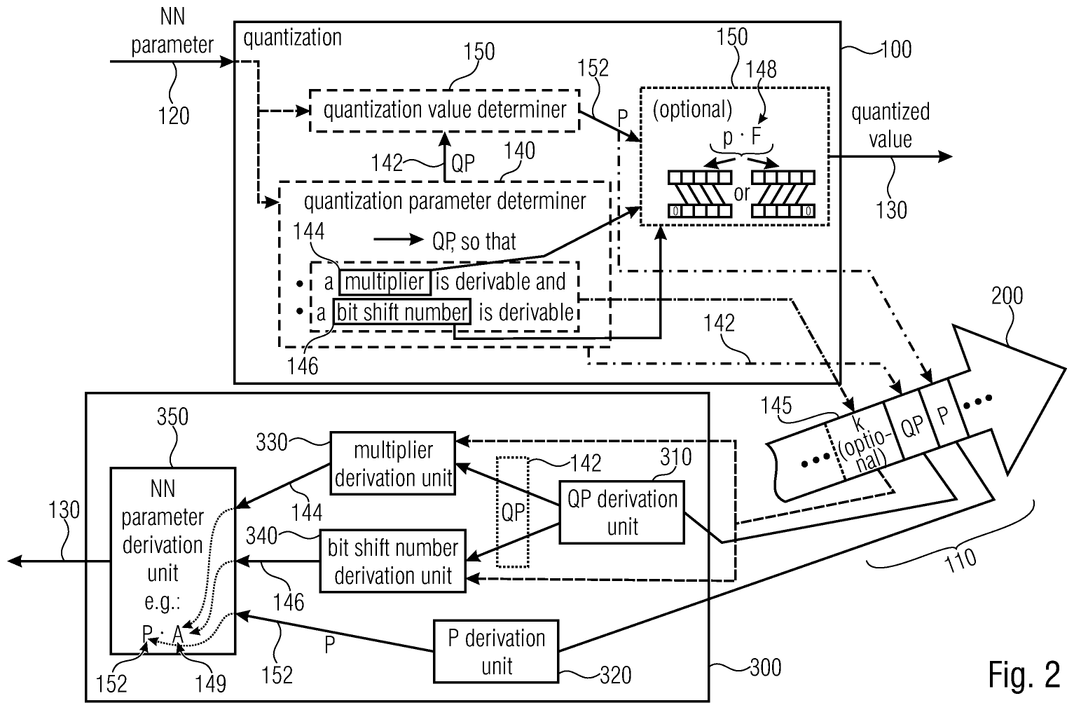

FIG. 2 shows an apparatus 100 for generating a NN representation 110. The apparatus 100 is configured to quantize a NN parameter 120 onto a quantized value 130 by determining 140 a quantization parameter 142 and by determining 150 a quantization value 152 for the NN parameter 120. The quantization value 152 might be determined 150 based on the quantization parameter 142. The determination 140 of the quantization parameter 142 might be performed by a quantization parameter determiner. The determination 150 of the quantization value 152 might be performed by a quantization value determiner.

The quantization parameter 142 is determined 140, so that from the quantization parameter 142, there is derivable a multiplier 144 and a bit shift number 146. At the determination 140 of the quantization parameter 142, the apparatus 100 might, for example, already check whether the multiplier 144 and the bit shift number 146 are derivable from the determined quantization parameter 142.

Optionally, the apparatus 100 might be configured to derive the multiplier 144 from the quantization parameter 142 and derive the bit shift number 146 from the quantization parameter 142, e.g., to allow a determination of the quantized value 130 by the apparatus 100. However, this is not necessary, since the quantized value 130 can be represented by the quantization parameter 142 and the quantization value 152. It is not necessary that the apparatus 100 explicitly determines the quantized value 130.

According to an embodiment, the generated NN representation 110 might comprise the determined quantization parameter 142 and the determined quantization value 152, so that the NN parameter 120, i.e. the quantized value 130 of the NN parameter 120, is derivable from the NN representation 110. For example, the apparatus 100 might be configured to encode the quantization parameter 142 and the quantization value 152 into the NN representation 110.

The multiplier 144 is to be derivable from the quantization parameter 142 based on a remainder of a division between a dividend derived by the quantization parameter 142 and a divisor derived by an accuracy parameter k 145.

The bit shift number 146 is to be derivable from the quantization parameter 142 based on a rounding of a quotient of the division, i.e. based on a rounding of the quotient of the division between the dividend derived by the quantization parameter 142 and a divisor derived by an accuracy parameter k 145.

The determination 140 of the quantization parameter 142 is performed, so that the quantized value 130 of the NN parameter 120 corresponds to a product between the quantization value 152 and a factor 148 which depends on the multiplier 144, bit-shifted by a number of bits which depends on the bit shift number 146. The quantized value 130 of the NN parameter 120 corresponds to the product, e.g., at least in terms of the quantized value's absolute value with a separate treatment of the sign in case of the shift, or even in terms of both absolute value and sign such as in case of using the two's complement representation and two's complement arithmetic respectively, for the product, its factors and the shift. This is exemplarily and schematically shown in the unit 150.

According to an embodiment, the apparatus 100 is configured to provide the NN parameter, e.g. the quantized value 130 of the NN parameter 120, by training a NN 20 using a floating-point representation for the NN parameter, and by determining the quantization parameter 142 and the quantization value 152 for the NN parameter by way of an iterative optimization scheme aiming at reducing a quantization error.

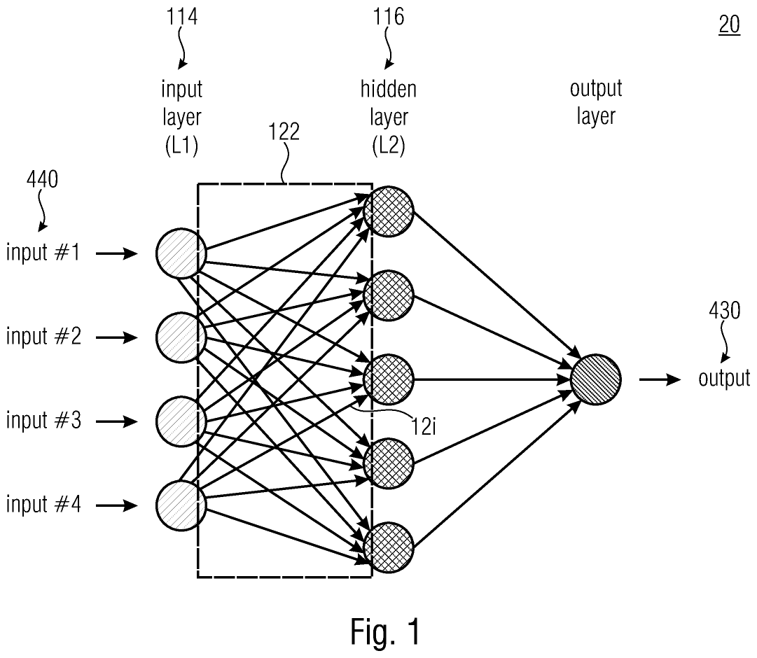

Apart from the apparatus 100, FIG. 1 shows digital data 200 defining the NN representation 110 and an apparatus 300 for deriving a NN parameter, i.e. the quantized value 130 of the NN parameter 120, from the NN representation 110. Due to the fact, that the digital data 200 and the apparatus 300 never see the original value of the NN parameter, the quantized value 130 will be understood as the value of the NN parameter in this context. For this reason, the NN parameter will be denoted with 130 for the following description of the digital data 200 and the apparatus 300. It is clear that the NN parameter discussed herein can be represented by the original value 120 assigned to the NN parameter or by the quantized value 130 determined based on the original value 120. Hence, the NN parameter will be denoted in the following with 120/130 in case of describing features, which are, for example, generally applicable regardless whether the NN parameter is represented by the original value 120 or the quantized value 130.

The digital data 200 defines a NN representation 110, the NN representation 110 comprising, for representing a NN parameter 130, the quantization parameter 142 and the quantization value 152, so that from the quantization parameter 142, there is derivable the multiplier 144 based on the remainder of the division between the dividend derived by the quantization parameter 142 and the divisor derived by the accuracy parameter k 145 and, so that from the quantization parameter 142, there is derivable the bit shift number 146 based on the rounding of the quotient of the division. The NN representation 110 comprises the quantization parameter 142 and the quantization value 152, so that the NN parameter 130 corresponds to the product between the quantization value 152 and the factor 148 which depends on the multiplier 144, bit-shifted by a number of bits which depends on the bit shift number 146.

The apparatus 300 for deriving the NN parameter 130 from the NN representation 110 is configured to derive the quantization parameter 142 from the NN representation 110, e.g., using a quantization parameter derivation unit 310, and derive a quantization value 152 from the NN representation 110, e.g., using a quantization value derivation unit 320. Additionally, the apparatus 300 is configured to derive, from the quantization parameter 142, the multiplier 144 and the bit shift number 146. The apparatus 300 is configured to derive the multiplier 144 based on the remainder of the division between the dividend derived by the quantization parameter 142 and the divisor derived by the accuracy parameter 145 and derive the bit shift number 146 based on the rounding of the quotient of the division. The derivation of the multiplier 144 might be performed using a multiplier derivation unit 330 and the derivation of the bit shift number 146 might be performed using a bit shift number derivation unit 340. The NN parameter 130 corresponds to a product between the quantization value 152 and a factor 148 which depends on the multiplier 144, bit-shifted by a number of bits which depends on the bit shift number 146, see the corresponding description above for the apparatus 100 and the unit 150 in FIG. 2. The NN parameter 130 might, for example, be derived using a NN parameter derivation unit 350. The NN parameter derivation unit 350 might comprise the same features and/or functionalities as the optional unit 150 of the apparatus 100.

In the following, embodiments and examples are presented, which are applicable to both, the apparatus 100 and the apparatus 300.

According to an embodiment, the NN parameter 120/130 is one of a weight parameter, a batch norm parameter and a bias. The weight parameter, e.g., w a component of W, might be usable for weighting an inter-neuron activation feed-forward between a pair of neurons or, alternatively speaking, might represent a weight relating to an edge which connects a first neuron and a second neuron and weighting the forwarding of the activation of the first neuron in the summation of inbound activations for the second neuron. The batch norm parameter, e.g., μ, σ², γ, β, might be usable for parametrizing an affine transformation of a neural network layer, and the bias, e.g. a component of bᵢ, might be usable for biasing a sum of inbound inter-neuron activation feed-forwards for a predetermined neural network neuron.

According to an embodiment, the NN parameter 120/130 parametrizes a NN 20, e.g., as shown in FIG. 1, in terms of a single 12ᵢ, e.g. w a component of W, inter-neuron activation feed-forward of a plurality 122 of inter-neuron activation feed-forwards of the NN. The apparatus 100/the apparatus 300 is configured to encode/derive, for each of the plurality 122 of inter-neuron activation feed-forwards, a corresponding NN parameter 120/130 into/from the NN representation 110. The corresponding NN parameter 130 is included in the NN representation 110. In this case, the apparatus 100 might be configured to for each of the plurality 122 of inter-neuron activation feed-forwards, quantize the corresponding NN parameter 120 onto the corresponding quantized value 130 by determining 140 an associated quantization parameter 142 associated with the respective inter-neuron activation feed-forward 12ᵢ and an associated quantization value 152 associated with the respective inter-neuron activation feed-forward 12ᵢ. The determination 140 of the associated quantization parameter 142 is performed so that from the associated quantization parameter 142, there is derivable an associated multiplier 144 associated with the respective inter-neuron activation feed-forward 12ᵢ based on a remainder of a division between a dividend derived by the associated quantization parameter 142 and a divisor derived by an associated accuracy parameter 145 associated with the respective inter-neuron activation feed-forward 12ᵢ, and an associated bit shift number 146 associated with the respective inter-neuron activation feed-forward 12ᵢ based on a rounding of the quotient of the division. The corresponding apparatus 300 for this case is configured to, for each of the plurality 122 of inter-neuron activation feed-forwards, derive 310 the associated quantization parameter 142 associated with the respective inter-neuron activation feed-forward 12ᵢ from the NN representation 110 and derive 320 the associated quantization value 152 associated with the respective inter-neuron activation feed-forward 12ᵢ from the NN representation 110. The derivation 310 and 320 might be performed, e.g. by decoding from the NN representation 110, i.e. one per edge might be decoded. Additionally, the apparatus 300 is configured to, for each of the plurality 122 of inter-neuron activation feed-forwards, derive, from the associated quantization parameter 142, the associated multiplier 144 associated with the respective inter-neuron activation feed-forward 12ᵢ based on a remainder of a division between a dividend derived by the associated quantization parameter 142 and a divisor derived by an associated accuracy parameter 145 associated with the respective inter-neuron activation feed-forward 12ᵢ, and the associated bit shift number 146 associated with the respective inter-neuron activation feed-forward 12ᵢ based on a rounding of the quotient of the division, see 330 and 340. The derivation 330 and 340 might be performed, e.g. by decoding from the NN representation 110, i.e. one per edge might be decoded.

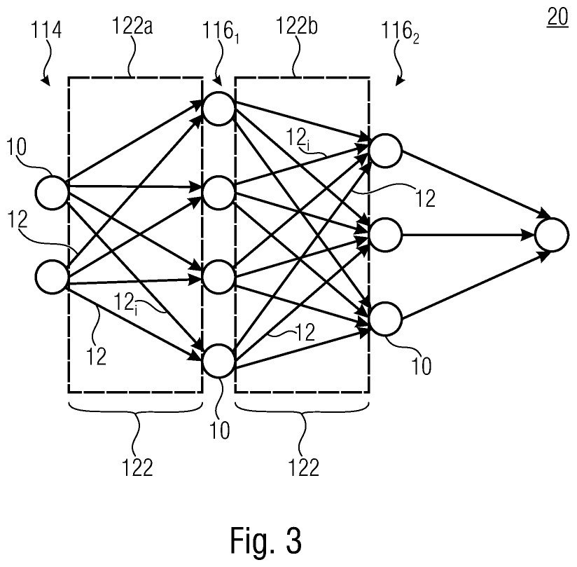

According to another embodiment, the apparatus 100/apparatus 300 is configured to subdivide a plurality 122 of inter-neuron activation feed-forwards of a NN 20 into sub-groups 122a, 122b of inter-neuron activation feed-forwards so that each sub-group is associated with an associated pair of NN layers of the NN and includes inter-neuron activation feed-forwards between the associated pair of NN layers and excludes inter-neuron activation feed-forwards between a further pair of NN layers other than the associated pair of layers, and more than one sub-group is associated with a predetermined NN layer, see for example FIG. 3. The sub-group 122a, for example, is associated with an associated pair of NN layers 114 and 116₁ of the NN 20 and includes inter-neuron activation feed-forwards between the associated pair of NN layers 114 and 116₁ and excludes inter-neuron activation feed-forwards between a further pair of NN layers, e.g., between the further pair of NN layers 116₁ and 116₂, other than the associated pair of layers 114 and 116₁. The sub-groups 122a and 122b are associated with the layer 116₁. The subdivisioning of the plurality 122 of inter-neuron activation feed-forwards of the NN 20 might be performed, e.g., by an index for each edge/weight 12 in the NN 20, or by otherwise segmenting the edges 12 between each layer pair. The NN parameter 120/130 parametrizes the NN 20 in terms of a single 12ᵢ inter-neuron activation feed-forward of the plurality 122 of inter-neuron activation feed-forwards of the NN 2. For each of the plurality 122 of inter-neuron activation feed-forwards, a corresponding NN parameter 120/130 is included in the NN representation 110. The apparatus 300 is configured to derive, e.g., by decoding from the NN representation, i.e. one per edge sub-group is decoded, for each of the plurality 122 of inter-neuron activation feed-forwards a corresponding NN parameter 120/130 from the NN representation 110. The apparatus 100/the apparatus 300 is configured to, for each sub-group 122a, 122b of inter-neuron activation feed-forwards, determine 140/derive 310 an associated quantization parameter 142 associated with the respective sub-group 122a or 122b. The quantization parameter 142 is determined 140 by the apparatus 100 so that the associated multiplier 144 associated with the respective sub-group 122a or 122b is derivable from the quantization parameter 142 based on a remainder of a division between a dividend derived by the associated quantization parameter 142 and a divisor derived by an associated accuracy parameter 145 associated with the respective sub-group, and the quantization parameter 142 is determined 140 by the apparatus 100 so that the associated bit shift number 146 associated with the respective sub-group 122a or 122b is derivable from the quantization parameter 142 based on a rounding of the quotient of the division. The apparatus 300 is configured to derive the associated multiplier 144 and the associated bit shift number 146 from the NN representation 110. The apparatus 100/the apparatus 300 is configured to, for each of the plurality 122 of inter-neuron activation feed-forwards, determine 150/derive 320 (derive 320, e.g. by decoding from the NN representation 110, i.e. one per edge is decoded) an associated quantization value 152 associated with the respective inter-neuron activation feed-forward 12ᵢ from the NN representation 110. The corresponding NN parameter 120/130 for the respective inter-neuron activation feed-forward 12ᵢ corresponds to a product between the associated quantization value 142 and the factor 148 which depends on the associated multiplier 144 associated with the sub-group, e.g., 122a or 122b, in which the respective inter-neuron activation feed-forward 12ᵢ is included, bit-shifted by a number of bits which depends on the associated bit shift number 146 of the sub-group, e.g., 122a or 122b, in which the respective inter-neuron activation feed-forward 12ᵢ is included.

The associated accuracy parameter 145, for example, is equally valued globally over the NN 20 or within each NN layer 114, 116₁ and 116₂. Optionally, the apparatus 100/the apparatus 300 is configured to encode/derive the associated accuracy parameter 145 into/from the NN representation 110.

According to an embodiment, the apparatus 100/the apparatus 300 is configured to encode/derive the quantization parameter 142 into/from the NN representation 110 by use of context-adaptive binary arithmetic encoding/decoding or by writing/reading bits which represent the quantization parameter 142 into/from the NN representation 110 directly or by encoding/deriving bits which represent the quantization parameter 142 from the NN representation 110 via an equi-probability bypass mode of a context-adaptive binary encoder/decoder of the apparatus 100/the apparatus 300. The apparatus 100/the apparatus 300 might be configured to derive the quantization parameter 142 from the NN representation 110 by binarizing/debinarizing a bin string using a binarization scheme. The binarization scheme, for example, is an Exponential-Golomb-Code.

According to an embodiment, the apparatus 100 is configured to determine 140 the quantization parameter 142 and encode same into the NN representation 110 in form of a fixed point representation, e.g. two's complement representation. The apparatus 300 might be configured to derive 310 the quantization parameter 142 from the NN representation 110 in form of a fixed point representation, e.g. two's complement representation. Optionally, the accuracy parameter 145 is 2, and a bit length of the fixed point representation, e.g., two's complement representation, is set to be constant for the NN 20 or set to be a sum of a basis bit length which is constant for the NN 20 and t.

According to an embodiment, the apparatus 100/the apparatus 300 is configured to configured to encode/derive the quantization parameter 142 into/from the NN representation 110 as an integer valued syntax element.

According to an embodiment the apparatus 100 is configured to determine the quantization value 152 and encode same into the NN representation 110 in form of a fixed point representation, e.g. two's complement representation. The apparatus 300 might be configured to derive 320 the quantization value 152 from the NN representation 110 in form of a fixed point representation, e.g. two's complement representation.

According to an embodiment, the apparatus 100/the apparatus 300 is configured to encode/derive the quantization value 152 into/from the NN representation 110 by binarizing/debinarizing the quantization value 152 into/from a bin string according to a binarization scheme, encoding/decoding bits of the bin string using context-adaptive arithmetic encoding/decoding.

According to an embodiment, the apparatus 100/the apparatus 300 is configured to encode/decode the quantization value 152 into/from the NN representation 110 by binarizing/debinarizing the quantization value 152 into/from a bin string according to a binarization scheme, encoding/decoding first bits of the bin string using context-adaptive arithmetic encoding/decoding and encoding/decoding second bits of the bin string using an equi-probability bypass mode.

According to an embodiment, a quantization step size A 149 can be derived, by the apparatus 100 and/or by the apparatus 300, from a signed integer number denoted quantization parameter QP 142 and a positive integer parameter k, i.e. the accuracy parameter 145, according to the following equations:

$$m u l = k + QP \% k$$

$$shift = ⌊ QP / k ⌋$$

$$Δ = \frac{m u l}{k} \cdot {2}^{shift}$$

The multiplier 144 is denoted by mul, the bit shift number 146 is denoted by shift and the factor 148 is denoted by

$$\frac{m u l}{k} .$$

The NN parameter 130 is

$$\frac{m u l}{k} \cdot {2}^{shift} \cdot P ,$$

wherein P is the quantization value 152.

The floor operator └ ┘ and modulo operator % are defined as follows:

└x┘ is the largest integer smaller or equal to x.
x % y is the modulo operator defined as x−y·└x/y┘.

Optionally, the apparatus 100 and/or the apparatus 300 might be configured to set the accuracy parameter k 145 to a default value.

Alternatively, the apparatus 100 might optionally test several different integer values for the accuracy parameter k 145 such as natural numbers or powers of two. The different integer values are, for example, tested for the whole NN or for each section of the NN such as each layer and the best accuracy parameter k 145 in terms of quantization error and bit rate such as in terms of a Langrange sum of the same is selected. The apparatus 100 might, for example, be configured to determine the accuracy parameter k 145 to check, e.g. at the determination 140, whether the multiplier 144 and the bit shift number 146 are derivable from the quantization parameter 142. Optionally, the accuracy parameter k 145 selected by the apparatus 100 is signaled in the NN representation 110, e.g., encoded into the NN representation 110. The apparatus 300, for example, is configured to derive the accuracy parameter k 145 from the NN representation 110.

According to an embodiment, the accuracy parameter 145 is a power of two.

According to an embodiment, the apparatus 100/the apparatus 300 is configured to encode/derive the accuracy parameter 145 into/from the NN representation 110 by writing/reading bits which represent the accuracy parameter 145 into/from the NN representation 110 directly or by deriving bits which represent the accuracy parameter 145 into/from the NN representation 110 via an equi-probability bypass mode of a context-adaptive binary encoder/decoder of the apparatus 100/the apparatus 300.

Instead of signaling a 32 bit floating point value in a bitstream, e.g. the digital data 200, only parameters QP 142 and k 145 need to be signaled. For some applications it may even be sufficient to only signal QP 142 in the bitstream and set k 145 to some fixed value.

In an embodiment, parameter QP′=QP−QP₀ is signaled in the bitstream instead of QP 142 where parameter QP₀ is a predefined constant value. In other words, according to an embodiment, the apparatus 100/the apparatus 300 is configured to encode/derive the associated quantization parameter QP 142 into/from the NN representation 110 in form of a difference to a reference quantization parameter QP₀.

In another embodiment, k 145 is set to 2^{t}. In this way, the calculation of Δ 149 can be carried out without a division as follows:

Δ=mul·2^{shift-t}

This allows for some computations to be carried out in integer domain instead of floating point domain as exemplified in the following.

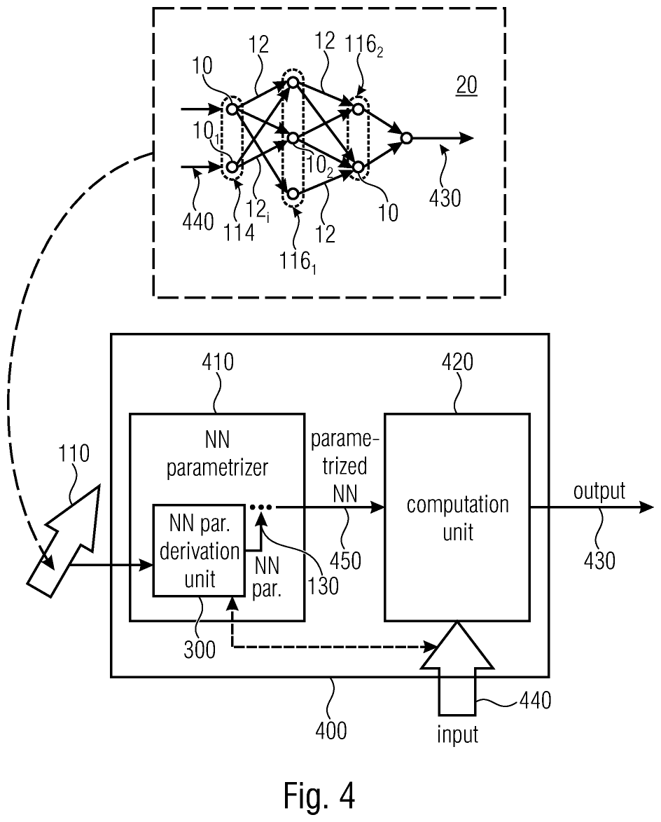

FIG. 4 shows schematically a device 400 for performing an inference using a NN 20. The device 400 comprises a NN parametrizer 410 configured to parametrize the NN 20. The NN parametrizer 410 comprises an apparatus 300 for deriving a NN parameter 130 from a NN representation 110. The apparatus 300 for deriving the NN parameter 130 might comprise the same or similar features as described with regard to the apparatus 300 in FIG. 2. The apparatus 300 might be understood as a NN parameter derivation unit. Additionally, the device 400 comprises a computation unit 420 configured to compute an inference output 430 based on a NN input 440 using the NN 20, e.g., using a parametrization 450 of the NN 20 determined by the NN parametrizer 410.

### Example 1

According to an embodiment, the NN parametrizer 410 is configured to derive, via the apparatus 300, at least one of a first NN parameter and a second NN parameter, so that the first NN parameter corresponds to a product between a first quantization value and a first factor, bit-shifted by a first number of bits, and the second NN parameter corresponds to a product between a second quantization value and a second factor, bit-shifted by a second number of bits.

The first quantization value and the second quantization value represent both a quantization value denoted with 152 in FIG. 2. The first factor and the second factor represent both a factor denoted with 148 in FIG. 2.

For example, let t=2 and let k=2^{t} and define a first QP, i.e. a first quantization parameter 142, denoted QPₐ, an associated shiftₐ, i.e. a first bit shift number 146, mulₐ, i.e. a first multiplier 144, and Δₐ, i.e. a first quantization step size 149.

Furthermore, define a second QP, i.e. a second quantization parameter 142, denoted QP_{b}, an associated shift_{b}, i.e. a second bit shift number 146, mul_{b}, i.e. a second multiplier 144, and Δ_{b}, i.e. a second quantization step size 149.

Although the ‘first’ parameters and the ‘second’ parameters are denoted in this context with the same reference numeral, it is clear that they can have different values. They are only denoted with the same reference numerals to make clear to which feature shown in FIG. 2 they belong to.

Consider a first quantized matrix Cₐ for which C=Δₐ·Cₐ holds.

Consider a second quantized matrix D_{b} for which D=Δ_{b}·D_{b} holds.

I.e., Cₐ was quantized using QPₐ and D_{b} was quantized using QP_{b}.

Both matrices shall have the same dimensions. The quantization value 152, discussed in

FIG. 2, might represent one component of Cₐ or one component of D_{b}. For example, Cₐ might comprise a plurality of first quantization values 152 and D_{b} might comprise a plurality of second quantization values 152.

Furthermore, assume that the sum C+D shall be calculated as follows:

$$\begin{matrix}C + D = {Δ}_{a} \cdot {C}_{a} + {Δ}_{b} \cdot {D}_{b} = {2}^{{shift}_{a} - 2} \cdot {mul}_{a} \cdot {C}_{a} + {2}^{{shift}_{b} - 2} \cdot {mul}_{b} \cdot {D}_{b} \\ = {2}^{{shift}_{a} - 2} \cdot ( mu {l}_{a} \cdot {C}_{a} + {2}^{{shift}_{b} - {shift}_{a}} \cdot {mul}_{b} \cdot {D}_{b} )\end{matrix}$$

The device 400 is configured to subject the first NN parameter C and the second NN parameter D to a summation to yield a final NN parameter of the NN 20 by forming a sum between a first addend, e.g., mulₐ·Cₐ, formed by a first quantization value Cₐ for the first NN parameter C, weighted with the first multiplier mulₐ, and a second addend, e.g., 2^{shift}^{_{b}}^{-shift}^{ₐ}·mul_{b}·D_{b}, formed by a second quantization value D_{b} for the second NN parameter D, weighted with the second multiplier mul_{b} and bit shifted by a difference of the first and second numbers of bits, see 2^{shift}^{_{b}}^{-shift}^{ₐ}, and subjecting the sum of the first and second addends to a bit shift 2^{shift}^{ₐ}⁻² by a number of bits which depends on one of the first and second numbers of bits, e.g., it depends on the first bit shift number shiftₐ or on the second bit shift number shift_{b}.

Optionally, this calculation/computation might be performed by the computation unit 420. In this case, the computation unit 420 is configured to, in performing the computation, subject the first NN parameter C and the second NN parameter D to the summation to yield the final NN parameter of the NN 20, as described above.

As can be seen from the equation, it is not necessary to derive C and D, which could need floating point operations. Instead, elements of Cₐ, i.e. first quantization values 152, are simply multiplied with mulₐ, i.e. a first multiplier 144, and elements of D_{b}, i.e. second quantization values 152, are multiplied with mul_{b}, i.e. a second multiplier 144, and the factor 2^{shift}^{_{b}}^{-shift}^{ₐ} is implemented as a simple bit shift operation, which depends on a first bit shift number shift_{b} 146 associated with the first quantization values 152 of Cₐ, i.e. components of Cₐ, and on a second bit shift number shift_{b} 146 associated with the second quantization values 152 of D_{b}, i.e. components of D_{b}. Note that since t=2, the integer variables mulₐ and mul_{b} are both one of the values 4, 5, 6, and 7. Integer multiplications with such small numbers can very efficiently be implemented in hardware or software implementations.

According to an embodiment, the first NN parameter represents a base layer representation of the NN 20 and the second NN parameter represents an enhancement layer representation of the NN 20. Alternatively, the first NN parameter, for example, represents a current representation of the NN 20 and the second NN parameter represents an update of the current NN representation, i.e. an update of current representation of the NN 20. Alternatively, for example, the first NN parameter represents a bias, i.e. a component of bᵢ, for biasing a sum of inbound inter-neuron activation feed-forwards for a predetermined neural network neuron 10 and the second NN parameter represents a batch norm parameter, i.e. μ, σ², γ or β, for parametrizing an affine transformation of a neural network layer 114, 116₁ or 116₂, e.g. b+μ).

### Example 2

According to an embodiment, the NN parametrizer 410 is configured to derive, via the apparatus 300, at least one of a third NN parameter and a fourth NN parameter, so that the third NN parameter corresponds to a product between a third quantization value and a third factor, bit-shifted by a third number of bits, and the fourth NN parameter corresponds to a product between a fourth quantization value and a fourth factor, bit-shifted by a fourth number of bits.

The third quantization value and the fourth quantization value represent both a quantization value denoted with 152 in FIG. 2. The third factor and the fourth factor represent both a factor denoted with 148 in FIG. 2.

For example, let t=2 and let k=2^{t} and define a first QP, e.g., the third quantization parameter 142, denoted QPₐ, an associated shiftₐ, i.e. a third bit shift number 146, mulₐ, i.e. a third multiplier 144, and Δₐ, i.e. a third quantization step size 149.

Furthermore, define a second QP, e.g., a fourth quantization parameter 142, denoted QP_{b}, an associated shift_{b}, i.e. a fourth bit shift number 146, mul_{b}, i.e. a fourth multiplier 144, and Δ_{b}, i.e. a fourth quantization step size 149.

Although the ‘third’ parameters and the ‘fourth’ parameters are denoted in this context with the same reference numeral, it is clear that they can have different values. They are only denoted with the same reference numerals to make clear to which feature shown in FIG. 2 they belong to. The device 400 might be configured to derive only a third and/or a fourth parameter, or additionally a first and/or a second parameter, as described in example 1 above.

Consider a quantized matrix Wₐ for which W=ΔXₐ·Wₐ holds.

Consider a quantized transposed vector γ_{b} for which γ=Δ_{b}·γ_{b} holds.

I.e., Wₐ was quantized using QPₐ and γ_{b} was quantized using QP_{b}.

The quantization value 152, discussed in FIG. 2, might represent one component of Wₐ or one component of γ_{b}. For example, Wₐ might comprise a plurality of quantization values 152 and γ_{b} might comprise a plurality of quantization values 152.

Furthermore, assume that the element-wise product W·y shall be calculated as follows:

$$\begin{matrix}W \cdot γ = {Δ}_{a} \cdot {W}_{a} + {Δ}_{b} \cdot {γ}_{b} = {2}^{{shift}_{a} - 2} \cdot {mul}_{a} \cdot {W}_{a} + {2}^{{shift}_{b} - 2} \cdot {mul}_{b} \cdot {γ}_{b} \\ = {2}^{{shift}_{a} + {shift}_{b} - 4} \cdot {mul}_{a} \cdot {mul}_{b} \cdot {W}_{a} \cdot {γ}_{b} )\end{matrix}$$

This calculation/computation might be performed by the computation unit 420, e.g., by subjecting the third NN parameter W and the fourth NN parameter γ to a multiplication to yield a product by forming a product of a first factor formed by the third quantization value Wₐ for the third NN parameter W, a second factor formed by the third multiplier mulₐ, a third factor formed by the fourth quantization value γ_{b} for the fourth NN parameter γ, and a fourth factor formed by the fourth multiplier mul_{b}, bit shifted by a number of bits, e.g. 2^{shift}^{ₐ}^{+shift}^{_{b}}⁻⁴, corresponding to a sum including a first addend formed by the third number of bits shiftₐ and a second addend formed by the fourth number of bits shift_{b}.

As can be seen from the equation, it is not necessary to derive W and γ, which could need floating point operations. Instead, the computation mulₐ·mul_{b}·Wₐ·γ_{b} involves only integer multiplications and the subsequent multiplication with 2^{shift}^{ₐ}^{+shift}^{_{b}}⁻⁴ can be implemented as a bit-shift. Note that since t=2, the integer variables mulₐ and mul_{b} are both one of the values 4, 5, 6, and 7. Integer multiplications with such small numbers can very efficiently be implemented in hardware or software implementations.

According to an embodiment, the third NN parameter represents a weight parameter for weighting, e.g. w a component of W, an inter-neuron activation feed-forward from a first neuron 10₁ of a first NN layer 114 to a second neuron 10₂ of a second NN layer 116₂ or, alternatively speaking, the third NN parameter represents a weight relating to an edge 12ᵢ which connects a first neuron 10₁ and a second neuron 10₂ and weighting the forwarding of the activation of the first neuron 10₁ in the summation of inbound activations for the second neuron 10₂.

The fourth NN parameter, for example, represents a batch norm parameter, e.g., μ, σ², γ or β. The batch norm parameter, for example, is for adjusting an activation feed-forward amplification of the first neuron 10₁ with respect to the second NN layer 116₁, e.g. γ.

### Quantization of the Input X

According to an embodiment, the device 400 is configured to quantize the NN input X 440, e.g., using the apparatus 300, by quantizing an activation onto a quantized value, e.g. X″, by determining for the activation a fifth quantization parameter QP, i.e. a quantization parameter 142, and a fifth quantization value, e.g. X′, i.e. a quantization value 152, so that a derivation, from the fifth quantization parameter QP, of a fifth multiplier mul, i.e. a multiplier 144, based on a remainder of a division between a dividend derived by the fifth quantization parameter and a divisor derived by an accuracy parameter k, i.e. an accuracy parameter 145, associated with the activation and a fifth bit shift number shift, i.e. a bit shift number 146, based on a rounding of the quotient of the division results the quantized value corresponding to a product between the fifth quantization value and a factor

$$\frac{m u l}{k} ,$$

i.e. a factor 14b, which depends on the fifth multiplier, bit-shifted by a fifth number of bits which depends on the fifth bit shift number.

In an embodiment, the input X 440 of a biased layer or of a batch norm layer is also quantized using the quantization method of this invention, see the description of the apparatus 100 in FIG. 2. I.e., a quantization parameter QP and associated variables an associated shift, mul, and Δ(with t=2 and k=2^{t}) are selected and X is quantized to X′ so that X″=Δ·X′=mul·2^{shift-t}·X′ holds. Then, instead of using X for executing a biased layer or a batch norm layer, X″ is used as input. Note that X′ can usually be represented with much less bits per element than X which is another advantage for an efficient hardware or software implementation.

According to an embodiment, the NN parametrizer 410 is configured to derive, via the apparatus 300, a sixth NN parameter, so that the sixth NN parameter corresponds to a product between a sixth quantization value and a sixth factor

$$\frac{mul}{k} ,$$

bit-shifted by a sixth number of bits. The device 400 is configured to subject the sixth NN parameter and the activation to a multiplication to yield a product by forming a product of a first factor formed by a sixth quantization value for the sixth NN parameter, a second factor formed by the sixth multiplier, a third factor formed by the fifth quantization value, and a fourth factor formed by the fifth multiplier, bit shifted by a number of bits corresponding to a sum including a first addend formed by the sixth number of bits and a second addend formed by the fourth number of bits.

According to an embodiment, the sixth NN parameter represents a weight parameter W for weighting the input 440, whereby the product W*X can be calculated/computed.

Referring back to FIG. 2, in the following further optional features of the apparatus 100 and/or the apparatus 300 are described.

### Efficient Encoding and Decoding of Parameter QP

In an embodiment, parameter QP, i.e. the quantization parameter 142, is encoded/decoded by the apparatus 100/the apparatus 300 in/from the bitstream 200 using a signed Exponential-Golomb-Code of order K according to the following definition.

Another embodiment is the same as the previous embodiment with order K set to 0.

### Exponential-Golomb-Code for Unsigned Integers

The unsigned Exponential-Golomb-Code of an unsigned integer shall be according to the decoding specification of a syntax element ue(v) as defined in the High Efficiency Video Coding (HEVC) standard.

This specification is shortly reviewed in the following:

Decoding of an unsigned integer variable ‘decNum’ from a binary representation that was encoded with an unsigned Exponential-Golomb-Code of order K is defined according to the following pseudo-code:

leadingZeroBits = −1
for( b = 0; lb; leadingZeroBits++ )
b = read_bits( 1 )

The variable codeNum is then assigned as follows:

decNum=(2^{leadingZeroBits}−1)*2^{K}+read_bits(leadingZeroBits+K)

Function read_bits(x) reads x bits from the bitstream and returns them as unsigned integer number. The bits read are ordered from the most significant bit (MSB) to the least significant bit (LSB).

### Exponential-Golomb-Code for Signed Integers

The unsigned Exponential-Golomb-Code of a signed integer shall be according to the decoding specification of a syntax element se(v) as defined in the High Efficiency Video Coding (HEVC) standard.

This specification is shortly reviewed in the following:

Decoding of a signed integer ‘signedDecNum’ from a binaray representation encoded with a signed exponential-Golomb-Code is as follows. First, an unsigned integer is decoded according to the ue(v) syntax element decoding process of HEVC as described above. Secondly, the unsigned integer is converted to a signed integer according to the following equation:

signedDecNum=(−1)^{decNum+1}·┌decNum/2┐

The ceiling operator ┌x┐ returns the smallest integer greater or equal to x.

### Further Embodiments

In an embodiment, parameter k, i.e. the accuracy parameter 145, is set to 2^{t} and parameter t is encoded using an unsigned integer representation with bits_t bits (e.g with bits_t=3 or bits_t=4).

In another embodiment, parameter k, i.e. the accuracy parameter 145, is set to 2^{t} and parameter t is encoded using the Exponential-Golomb-Code for unsigned integers.

In another embodiment, parameter QP, i.e. the quantization parameter 142, is encoded using an Exponential-Golomb-Code for signed integers.

In another embodiment, parameter k, i.e. the accuracy parameter 145, is set to 2^{t} and parameter QP is encoded using a signed integer in two's complement representation using bits_qp bits. Either, bits_qp is set to a constant value like, e.g. 12 or 13, or bits_qp is set to bits_qp0+t and bits_qp0 is a nonzero constant integer value (e.g. bits_qp0=6).

In case of a CABAC-coded bitstream 200, bits representing parameters t and/or QP 142 can be either encoded as bypass bins (using the bypass mode of CABAC) or they can be directly written into the bitstream 200.

In another embodiment, each of the parameters W, b, μ, σ², γ, and β is quantized with an individual QP 142 value that is encoded immediately before encoding of the parameter.

In another embodiment, a first QP 142 is encoded into the bitstream 200 and associated with a subset of the parameters of the model. For each parameter x of this subset one QP-offset QPₓ is encoded per parameter and the effective QP 142 used for dequantizing the parameter, i.e. the NN parameter 120 is given as QP+QPₓ. The binary representation of QPₓ uses less bits than the binary representation of QP. For example, QPₓ is encoded using an Exponential-Golomb code for signed integers or a fixed number of bits (in two's complement representation).

### Further Embodiment Regarding the Coding of the Weight Parameters

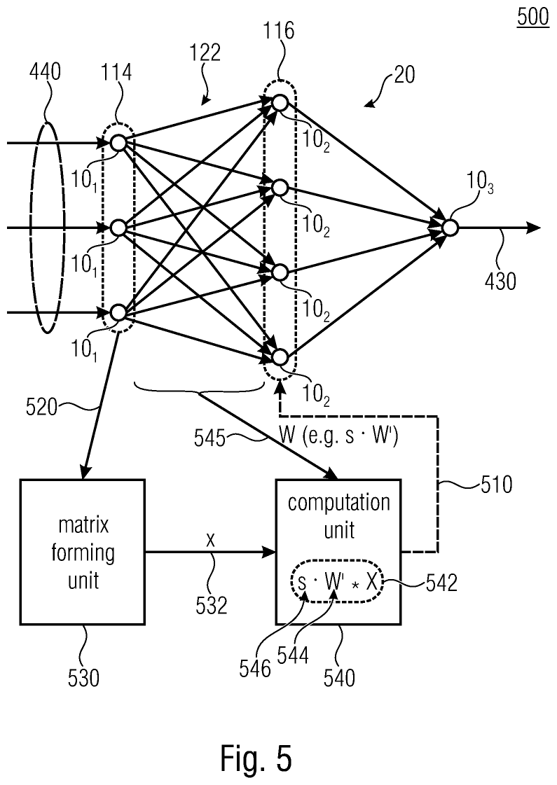

A further embodiment, shown in FIG. 5, is concerned with the representation of the weight parameters W 545. Namely, it factors them as a composition of a vector 546 and a matrix 544: W→s·W′. W and W′, i.e. a weight matrix 544, are matrices of dimensions n×m and s is a transposed vector 546 of length n. Each element of the vector s 546 is used as a row-wise scaling factor of the weight matrix W′ 544. In other words, s 546 is multiplied element-wise with each column of W′ 544. We call s 546 the local scaling factor or local scale adaptation (LSA).

FIG. 5 shows a device 500 for performing an inference using a NN 20. The device 500 is configured to compute an inference output 430 based on a NN input 440 using the NN 20. The NN 20 comprises a pair of NN layers 114 and 116 and inter-neuron activation feed-forwards 122 from a first 114 of the pair of NN layers to a second 116 of the NN layers. The device 500 is configured to compute activations 510 of the neural network neurons 10₂ of the second NN layer 116 based on activations 520 of the neural network neurons 10₁ of the first NN layer 114 by forming a matrix X 532 out of the activations 520 of the neural network neurons 10₁ of the first NN layer 114, e.g., using a matrix forming unit 530 of the device 500. Additionally, the device 500 is configured to compute the activations 510 of the neural network neurons 10₂ of the second NN layer 116 based on the activations 520 of the neural network neurons 10₁ of the first NN layer 114 by computing s·W′*X 542 wherein * denotes a matrix multiplication, W′ is a weight matrix 544 of dimensions n×m with n and m∈ [symbol] , s is transposed vector 546 of length n, and · denotes a column wise Hadamard multiplication between a matrix the one side of · and a transposed vector on the other side ·. The device 500 might comprise a computation unit 540 configured to perform the computation 542.

According to an embodiment, the transposed vector s 546 is the result of an optimization of W′ 544 in terms of higher compression for coding W′ 544 and/or higher inference fidelity.

The rationale is that LSA scales the weight matrix 544, such that arithmetic coding methods yield higher coding gain and/or increase the neural network performance results, e.g. achieve higher accuracy. For instance, after quantization of W, s 546 can be adapted in order to reduce the quantization error and as such increasing the prediction performance of the quantized neural network, either with or without using the input data 440, e.g. X 532.

Hence, s 546 and W′ 544 may have different quantization parameters, i.e. different QPs. This may not only be beneficial from a performance point of view, but also from a hardware efficiency perspective. For instance, W′ 544 may be quantized such that the dot product with the input X 532 can be performed in 8-bit representation, however, the subsequent multiplication with the scaling factors 546 in 16-bit. The device 500, for example, is configured to compute the matrix multiplication W′*X using n-bit fixed point arithmetic to yield a dot product and multiply the dot product with s 546 using m-bit fixed point arithmetic with m>n.

However, even if W′ 544 and s 546 are both quantized to an n-bit representation, a smaller n may be sufficient than would be needed to quantize W 545 to yield the same inference accuracy. Similarly, advantages in terms of representation efficiency may even be achieved, if s 546 was quantized to a representation of fewer bits than W′ 544.

According to an embodiment, the device 500 comprises a NN parametrizer, e.g., the NN parameterizer 410 shown in FIG. 4, configured to derive W′ 544 from a NN representation 110. The NN parametrizer comprises an apparatus, e.g., the apparatus 300 shown in FIG. 4 or FIG. 2, for deriving a NN parameter from the NN representation 110. The weight matrix W′ 544 may be the NN parameter derived by the apparatus 300. Optionally, the NN parametrizer 410 is further configured to derive s 546 from the NN representation 110 with using different quantization parameter 142 than compared to a NN parameter which relates to W′ 544.

In an embodiment, encoding of a weight matrix W 544 is as follows. First, a flag is encoded that indicates whether LSA is used. If the flag is 1, parameters s 546 and W′ 544 are encoded using a state-of-the-art parameter encoding scheme, like DeepCABAC. If the flag is 0, W 545 is encoded instead.

In another embodiment, according to the previous embodiment, different QP values are used for W′ 544 and s 546.

### Batch Norm Compression

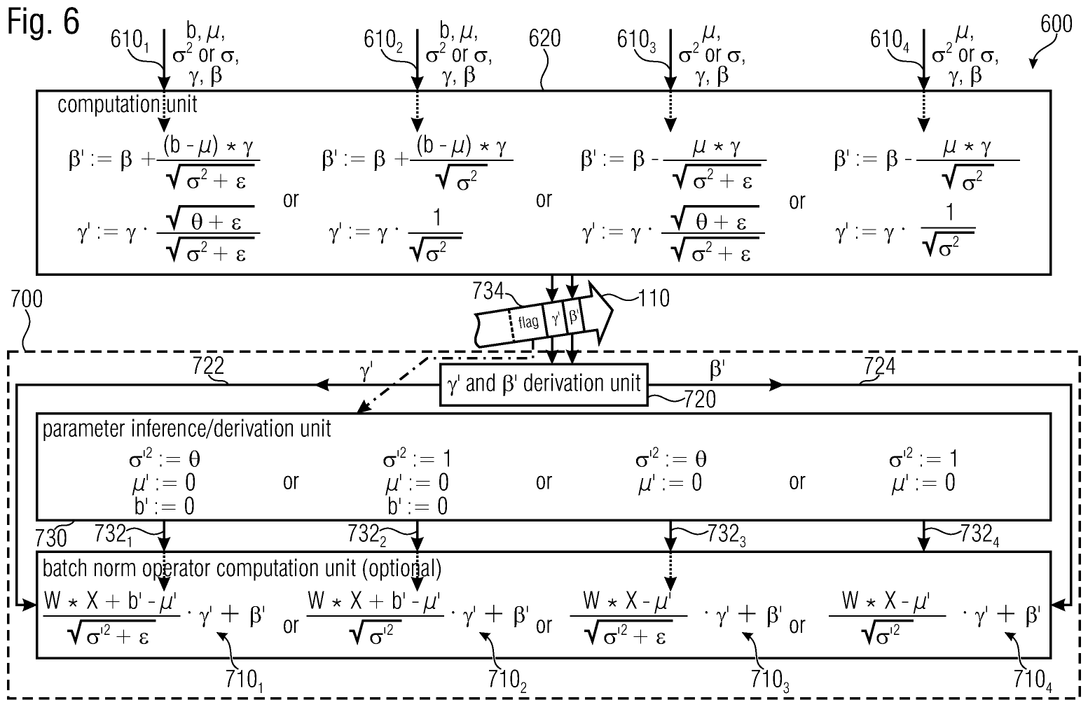

An embodiment, shown in FIG. 6, is related to improving a batch norm compression. FIG. 6 shows an apparatus 600 for coding NN parameters 610, e.g. μ, σ², γ, β, and optionally b, of a batch norm operator 710 of a NN into a NN representation 110 and an apparatus 700 for decoding the NN parameters 610, e.g. γ 722 and β 724 and the parameters 732, i.e. μ, σ² and optionally b, of the batch norm operator 710 of a NN from the NN representation 110. Shown are four embodiments, wherein the first embodiment explains the general case and the other embodiments are directed to special cases.

Generally, the batch norm operator 710₁ can be defined as

$$\frac{W * X + b - μ}{\sqrt{{σ}^{2} + ϵ}} \cdot γ + β$$

wherein
μ, σ², γ, and β are batch norm parameters, e.g. transposed vectors comprising one component for each output node,
W is a weight matrix, e.g. each row of which is for one output node, with each component of the respective row being associated with one row of X,
X is an input matrix derived from activations of a NN layer,
b is a transposed vector forming a bias, e.g. transposed vector comprising one component for each output node,
ϵ is a constant for division-by-zero avoidance,
· denotes a column wise Hadamard multiplication between a matrix the one side of and a transposed vector on the other side, and
* denotes a matrix multiplication.

For the second embodiment, the constant E is zero resulting in a batch norm operator 7102 being defined by

$$\frac{W * X + b - μ}{\sqrt{{σ}^{2} + ϵ}} \cdot γ + β .$$

For the third embodiment, the bias b is zero resulting in a batch norm operator 710₃ being defined by

$$\frac{W * X - μ}{\sqrt{{σ}^{2} + ϵ}} \cdot γ + β .$$

For the fourth embodiment, the bias b and the constant E are zero resulting in a batch norm operator 710₄ being defined by

$$\frac{W * X - μ}{\sqrt{{σ}^{2}}} \cdot γ + β .$$

In FIG. 6 some parameters of the batch norm operators 710 have an apostrophe to enable a distinction between original parameters 610 indicated by parameters without an apostrophe and modified parameters 722, 724 and 732 indicated by parameters with an apostrophe. It is clear that either the original parameters 610 or the modified parameters 722, 724 and 732 can be used as the parameters of one of the above defined batch norm operators 710.

The apparatus 600 is configured to receive the parameters μ, γ, β and σ² or σ, see 610₁ to 610₄, and optionally b, see 610₁ and 610₂.

According to the first embodiment, the apparatus 600 is configured to compute

$${β}^{′} := β + \frac{( b - μ ) * γ}{\sqrt{{σ}^{2} + ϵ}} and {γ}^{′} := γ \cdot \frac{\sqrt{θ + ϵ}}{\sqrt{{σ}^{2} + ϵ}} .$$

According to the alternative second embodiment, the apparatus 600 is configured to compute

$${β}^{′} := β + \frac{( b - μ ) * γ}{\sqrt{{σ}^{2}}} and {γ}^{′} := γ \cdot \frac{1}{\sqrt{{σ}^{2}}} .$$

According to the alternative third embodiment, the apparatus 600 is configured to compute

$${β}^{′} := β - \frac{μ * γ}{\sqrt{{σ}^{2} + ϵ}} and {γ}^{′} := γ \cdot \frac{\sqrt{θ + ϵ}}{\sqrt{{σ}^{2} + ϵ}} .$$

According to the alternative fourth embodiment, the apparatus 600 is configured to compute

$${β}^{′} := β - \frac{μ * γ}{\sqrt{{σ}^{2}}} and {γ}^{′} := γ \cdot \frac{1}{\sqrt{{σ}^{2}}} .$$

The computed parameters β′ and γ′ are coded into the NN representation 110 as NN parameters of the batch norm operator 710, e.g. so that same (β′ and γ′) are also transposed vectors comprising one component for each output node.

Thus, the batch norm operator 710₁ for the first embodiment can be defined as

$$\frac{W * X + {b}^{′} - {μ}^{′}}{\sqrt{{σ}^{′2} + ϵ}} \cdot {γ}^{′} + {β}^{′}$$

with σ′²=θ, μ′:=0 and b′:=0, wherein θ is a predetermined parameter. The batch norm operator 710₂ for the second embodiment can be defined as

$$\frac{W * X + {b}^{′} - {μ}^{′}}{\sqrt{{σ}^{′2}}} \cdot {γ}^{′} + {β}^{′}$$

with σ′²:=1, μ′:=0 and b′:=0. The batch norm operator 710₃ for the third embodiment can be defined as

$$\frac{W * X - {μ}^{′}}{\sqrt{{σ}^{′2} + ϵ}} \cdot {γ}^{′} + {β}^{′}$$

with σ′²:=θ and μ′:=0, wherein θ is a predetermined parameter and the batch norm operator 710₄ for the fourth embodiment can be defined as

$$\frac{W * X - {μ}^{′}}{\sqrt{{σ}^{′2}}} \cdot {γ}^{′} + {β}^{′}$$

with σ′²:=1 and μ′:=0.

The predetermined parameter is 1 or 1−ϵ, e.g., again μ′, σ′², γ′, and β′ are transposed vectors comprising one component for each output node, W is the weight matrix, X is the input matrix derived from activations of a NN layer, b′ is a transposed vector forming a bias, e.g. transposed vector comprising one component for each output node.

The apparatus 700 is configured to derive γ and β, i.e. γ′ and β′, from the NN representation, e.g. by using a γ and β derivation unit 720, which might be comprised by the apparatus 700.

According to the first embodiment, the apparatus 700 is configured to infer, or derive by way of one signaling 734 applying to all components thereof, that σ′²:=θ, μ′:=0 and b′:=0, wherein θ is a predetermined parameter.

According to the second embodiment, the apparatus 700 is configured to infer, or derive by way of one signaling 734 applying to all components thereof, that σ′²:=1, μ′:=0 and b′:=0.

According to the third embodiment, the apparatus 700 is configured to infer, or derive by way of one signaling 734 applying to all components thereof, that σ′²:=θ and μ′:=0, wherein θ is a predetermined parameter.

According to the fourth embodiment, the apparatus 700 is configured to infer, or derive by way of one signaling 734 applying to all components thereof, that σ′²:=1 and μ′:=0.

This derivation or inference of the parameters σ′², μ′ and optionally b′ might be performed using a parameter inference/derivation unit 730.

The predetermined parameter is 1 or 1−ϵ, e.g., again μ′, σ′², γ′, and β′ are transposed vectors comprising one component for each output node, W is the weight matrix, X is the input matrix derived from activations of a NN layer, b′ is a transposed vector forming a bias, e.g. transposed vector comprising one component for each output node.

In FIG. 6 the parameters derived or inferred by the apparatus 700 are indicated by an apostrophe, however due to the fact that the apparatus 700 never sees the original parameters 610, the parameters derived or inferred by the apparatus 700 might also be indicated without using in apostrophe. In view of the apparatus 700, the derived or inferred parameters are the only existing parameters.

Optionally, the apparatus 700 might be configured to use the batch norm operator with the derived or inferred parameters 722, 724 and 732, e.g., for inference. A batch norm operator computation unit might be configured to use the batch norm operator. Alternatively, a device for inference, e.g. the device 400 or the device 500, might comprise the apparatus 700 to obtain the parameters of the batch norm operator 710.

Introducing the constant scalar value θ, i.e. the predetermined parameter, which, for example, could be equal to 1 or 1−ϵ, parameters b, μ, σ², γ, and β can be modified by the following ordered steps without changing the result of BN(X), i.e. of the batch norm operator 710:

$$β := β + \frac{( b - μ ) * γ}{\sqrt{{σ}^{2} + ϵ}} \qquad 1 )$$

$$γ := γ \cdot \frac{\sqrt{θ + ϵ}}{\sqrt{{σ}^{2} + ϵ}} \qquad 2 )$$

$${σ}^{2} := θ \qquad 3 )$$

$$μ := 0 \qquad 4 )$$

$$b := 0 \qquad 5 )$$

Each of the operations shall be interpreted as element-wise operations on the elements of the transposed vectors. Further modifications that don't change BN(X) are also possible, as exemplified in the embodiments two to three. For example, bias b and mean μ are ‘integrated’ in β so that b and μ are afterwards set to 0, see the third embodiment. Or σ² could be set to 1−ϵ (i.e., θ=1−ϵ) in order to set the denominator of the fraction in BN(X) equal 1 when other parameters are adjusted accordingly.

As a result, b, σ², μ and b can be compressed much more efficiently as all vector elements have the same value.

In an embodiment, a flag 734 is encoded that indicates whether all elements of a parameter have a predefined constant value. A parameter may, for example, be b, μ, σ², γ, or β. Predefined values may, for example, be 0, 1, or 1−ϵ. If the flag is equal to 1, all vector elements of the parameter are set to the predefined value. Otherwise, the parameter is encoded using one of the state-of-the-art parameter encoding methods, like e.g., DeepCABAC.

In another embodiment, a flag is encoded per parameter indicating whether all vector elements have the same value. When all vector elements have the same value, the flag is equal to 1 the value is encoded using a state-of-the-art parameter encoding method like, e.g., DeepCABAC, or and Exponential-Golomb-Code, or a fixed-length code. If the flag is 0, the vector elements of the parameter is encoded using one of the state-of-the-art parameter encoding methods, like e.g. DeepCABAC.

According to an embodiment, the apparatus 600/the apparatus 700 is configured to indicate/derive in/from the representation 110 that all components, e.g., each component is for a corresponding row of W meaning for a corresponding output node, of σ′² are equal to each other, and the value thereof. Additionally or Alternatively, the apparatus 600/the apparatus 700 is configured to indicate/derive in/from the representation 110 that all components, e.g., each component is for a corresponding row of W meaning for a corresponding output node, μ′ are equal to each other, and the value thereof. Additionally or Alternatively, the apparatus 600/the apparatus 700 is configured to indicate/derive in/from the representation 119 that, if present, e.g. in case of the first and second embodiment but not in case of the third and fourth embodiment, all components, e.g., each component is for a corresponding row of W meaning for a corresponding output node, of b′ are equal to each other, and the value thereof.

According to an embodiment, the apparatus 600 is configured to be switchable between two batch norm coding modes, wherein, in a first batch norm coding mode, the apparatus 600 is configured to perform the computing and the coding of β′ and γ′ and in a second batch norm coding mode, the apparatus is configured to code the received μ, α² or α, γ, and β, and, if present, b. In other words, the received parameters 610 are directly encoded into the representation 110 in the second batch norm mode. Parallel, the apparatus 700 might also be configured to be switchable between two batch norm coding modes, wherein, in a first batch norm coding mode, the apparatus 700 is configured to perform the deriving and the inferring or deriving and in second first batch norm coding mode, the apparatus 700 is configured to decode μ, α² or σ, γ, and β, and, if present, b from the representation 110. In other words, the parameters 610 are directly decoded from the representation 110 in the second batch norm mode.

According to an embodiment, the apparatus 600 comprises the apparatus 100, see FIG. 2, so as to quantize and code β′ and γ′ into the NN representation 110. For example, the apparatus 600 performs at first the computation 620 and passes the obtained parameters β′ and γ′ to the apparatus 100 for the quantization of the parameters. According to an embodiment, the apparatus 700 comprises the apparatus 300, see FIG. 2, to derive β and γ from the NN representation 110.

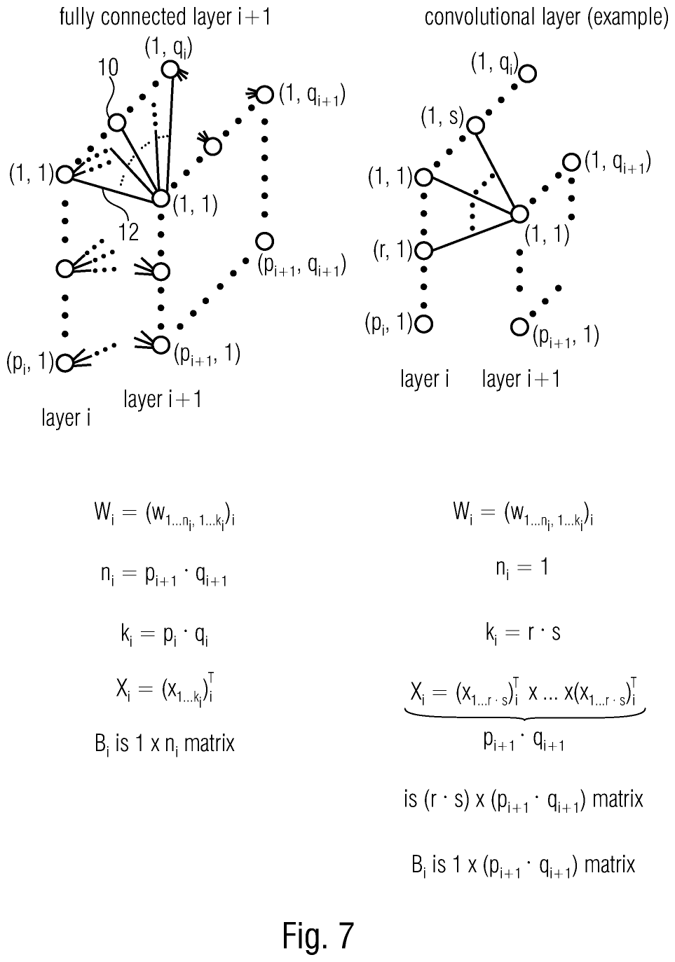

For ease of understanding, possible relationships between X and W and a pair of layers is depicted in FIG. 7: Left a fully connected layer i+1, and right a convolutional layer i+1. Neurons of the layers are depicted by circles 10. The neurons of each layer are positioned at array positions (x,y). Each layer i has qᵢ columns of neurons 10 and pᵢ rows of neurons 10. In the fully connected case, Xᵢ is a vector of components X_{1 . . . p}_{ᵢ}_{·q}_{ᵢ} where each X_{g} is populated with an activation of neuron at position {┌g/qᵢ┐;g % qᵢ+1} and Wᵢ is a matrix of components W_{1 . . . p}_{ᵢ₊₁}_{·q}_{ᵢ₊₁}_{,1 . . . p}_{ᵢ}_{·q}_{ᵢ} where each W_{g,h} is populated with a weight for the edge 12 between neuron 10 of layer i+1 at position {┌g/qᵢ₊₁┐;g % qᵢ+1} and neuron 10 of layer i at position {┌h/qᵢ┐;h % qᵢ+1}. In the convolutional case, Xᵢ is a matrix of components X_{1 . . . r·s,1 . . . p}_{ᵢ₊₁}_{·q}_{ᵢ₊₁} where each X_{g,h} is populated with an activation of a neuron at position {┌(g+(h−1)*qᵢ/(qᵢ₊₁+s−1))/s┐; (g+(h−1)*qᵢ/(qᵢ₊ᵢ+s−1))% s+1} and Wᵢ is a vector of components W_{1 . . . r·s} where each W_{g,h} is populated with a weight for an edge leading from a neuron in a rectangular filter kernel of size r×s in layer i positioned at one of pᵢ₊₁·qᵢ₊₁ positions distributed over layer i to a neuron positions in layer i+1 which corresponds to the kernel position.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

The inventive digital data, data stream or file containing the inventive NN representation can be stored on a digital storage medium or can be transmitted on a transmission medium such as a wireless transmission medium or a wired transmission medium such as the Internet.

Depending on certain implementation requirements, embodiments of the invention can be implemented in hardware or in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitionary.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

The apparatus described herein may be implemented using a hardware apparatus, or using a computer, or using a combination of a hardware apparatus and a computer.

The apparatus described herein, or any components of the apparatus described herein, may be implemented at least partially in hardware and/or in software.

The methods described herein may be performed using a hardware apparatus, or using a computer, or using a combination of a hardware apparatus and a computer.

The methods described herein, or any components of the apparatus described herein, may be performed at least partially by hardware and/or by software.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. Apparatus for generating a NN representation, the apparatus configured to quantize an NN parameter onto a quantized value by
determining a quantization parameter and a quantization value for the NN parameter so that from the quantization parameter, there is derivable
a multiplier based on a remainder of a division between a dividend derived by the quantization parameter and a divisor derived by an accuracy parameter and
a bit shift number based on a rounding of the quotient of the division,
so that the quantized value of the NN parameter corresponds to a product between the quantization value and a factor which depends on the multiplier, bit-shifted by a number of bits which depends on the bit shift number.

2. Digital data defining a NN representation, the NN representation comprising, for representing an NN parameter, a quantization parameter and a quantization value,
so that from the quantization parameter, there is derivable
a multiplier based on a remainder of a division between a dividend derived by the quantization parameter and a divisor derived by an accuracy parameter and
a bit shift number based on a rounding of the quotient of the division, and
so that the NN parameter corresponds to a product between the quantization value and a factor which depends on the multiplier, bit-shifted by a number of bits which depends on the bit shift number.

3. Apparatus for deriving a NN parameter from a NN representation, configured to
derive a quantization parameter from the NN representation,
derive a quantization value from the NN representation, and
derive, from the quantization parameter,
a multiplier based on a remainder of a division between a dividend derived by the quantization parameter and a divisor derived by an accuracy parameter and
a bit shift number based on a rounding of the quotient of the division,
wherein the NN parameter corresponds to a product between the quantization value and a factor which depends on the multiplier, bit-shifted by a number of bits which depends on the bit shift number.

4. Apparatus of claim 3, further configured to derive the accuracy parameter from the NN representation.

5. Apparatus of claim 3, wherein the NN parameter is one of
a weight parameter for weighting an inter-neuron activation feed-forward between a pair of neurons,
a batch norm parameter for parametrizing an affine transformation of a neural network layer, and
a bias for biasing a sum of inbound inter-neuron activation feed-forwards for a predetermined neural network neuron.

6. Apparatus of claim 3, wherein the NN parameter parametrizes a NN in terms of a single inter-neuron activation feed-forward of plurality of inter-neuron activation feed-forwards of the NN and the apparatus is configured to derive for each of the plurality of inter-neuron activation feed-forwards, a corresponding NN parameter from the NN representation with
for each of the plurality of inter-neuron activation feed-forwards,
deriving an associated quantization parameter associated with the respective inter-neuron activation feed-forward from the NN representation,
deriving an associated quantization value associated with the respective inter-neuron activation feed-forward from the NN representation,
Derive, from the associated quantization parameter,
An associated multiplier associated with the respective inter-neuron activation feed-forward based on a remainder of a division between a dividend derived by the associated quantization parameter and a divisor derived by an associated accuracy parameter associated with the respective inter-neuron activation feed-forward, and
an associated bit shift number associated with the respective inter-neuron activation feed-forward based on a rounding of the quotient of the division,
wherein the corresponding NN parameter for the respective inter-neuron activation feed-forward corresponds to a product between the associated quantization value and a factor which depends on the associated multiplier, bit-shifted by a number of bits which depends on the associated bit shift number.

7. Apparatus of claim 3, wherein the apparatus is configured to subdivide a plurality of inter-neuron activation feed-forwards of a NN into sub-groups of inter-neuron activation feed-forwards so that each sub-group is associated with an associated pair of NN layers of the NN and comprises inter-neuron activation feed-forwards between the associated pair of NN layers and excludes inter-neuron activation feed-forwards between a further pair of NN layers other than the associated pair of layers, and more than one sub-group is associated with a predetermined NN layer,
the NN parameter parametrizes the NN in terms of a single inter-neuron activation feed-forward of the plurality of inter-neuron activation feed-forwards of the NN and the apparatus is configured to derive for each of the plurality of inter-neuron activation feed-forwards a corresponding NN parameter from the NN representation with
for each sub-group of inter-neuron activation feed-forwards,
deriving an associated quantization parameter associated with the respective sub-group from the NN representation,
Deriving, from the associated quantization parameter,
An associated multiplier associated with the respective sub-group based on a remainder of a division between a dividend derived by the associated quantization parameter and a divisor derived by an associated accuracy parameter associated with the respective sub-group, and
An associated bit shift number associated with the respective sub-group based on a rounding of the quotient of the division,
for each of the plurality of inter-neuron activation feed-forwards,
deriving an associated quantization value associated with the respective inter-neuron activation feed-forward from the NN representation,
wherein the corresponding NN parameter for the respective inter-neuron activation feed-forward corresponds to a product between the associated quantization value and a factor which depends on the associated multiplier associated with the sub-group in which the respective inter-neuron activation feed-forward is comprised, bit-shifted by a number of bits which depends on the associated bit shift number of the sub-group in which the respective inter-neuron activation feed-forward is comprised.

8. Apparatus of claim 6, wherein the associated accuracy parameter is equally valued globally over the NN or within each NN layer.

9. Apparatus of claim 6, configured to derive the associated accuracy parameter from the NN representation.

10. Apparatus of claim 6, configured to derive the associated quantization parameter from the NN representation in form of a difference to a reference quantization parameter.

11. Apparatus of claim 3, configured to derive, from the quantization parameter, the multiplier and the bit shift number according to
mul=k+QP%k
shift=└QP/k┘
wherein mul is the multiplier, shift is the bit shift number, QP is the quantization parameter, k is the accuracy parameter, └ ┘ is floor operator which yields the largest integer smaller or equal to its operand, and % is a modulo operator yielding x−y·└x/y┘ for x % y so that the NN parameter is
$$\frac{mul}{k} \cdot {2}^{shift} \cdot P$$
wherein P is the quantization value.

12. Apparatus of claim 3, the accuracy parameter is a power of two.

13. Apparatus of claim 3, configured to derive the quantization parameter from the NN representation
by use of context-adaptive binary arithmetic decoding or
by reading bits which represent the quantization parameter from the NN representation directly or
by deriving bits which represent the quantization parameter from the NN representation via an equi-probability bypass mode of a context-adaptive binary decoder of the apparatus.

14. Apparatus of claim 3, configured to derive the quantization parameter from the NN representation by debinarizing a bin string using a binarization scheme.

15. Apparatus of claim 14, wherein the binarization scheme is an Exponential-Golomb-Code.

16. Apparatus of claim 3, configured to derive the quantization parameter from the NN representation in form of a fixed point representation.

17. Apparatus of claim 16, wherein the accuracy parameter is 2^{t}, and a bit length of the fixed point representation is set to be constant for the NN or set to be a sum of a basis bit length which is constant for the NN and t.

18. Apparatus of claim 3, configured to derive the quantization parameter from the NN representation as an integer valued syntax element.

19. Apparatus of claim 3, configured to derive the accuracy parameter from the NN representation by reading bits which represent the accuracy parameter from the NN representation directly or by deriving bits which represent the accuracy parameter from the NN representation via an equi-probability bypass mode of a context-adaptive binary decoder of the apparatus.

20. Apparatus of claim 3, configured to derive the quantization value from the NN representation in form of a fixed point representation.

21. Apparatus of claim 3, configured to derive the quantization value from the NN representation by debinarizing the quantization value from a bin string according to a binarization scheme, and decoding bits of the bin string from the NN representation using context-adaptive arithmetic decoding.

22. Apparatus of claim 3, configured to derive the quantization value from the NN representation by debinarizing the quantization value from a bin string according to a binarization scheme, and decoding first bits of the bin string from the NN representation using context-adaptive arithmetic decoding and decoding second bits of the bin string using an equi-probability bypass mode.

23. Device for performing an inference using a NN, the device configured to compute an inference output based on a NN input using the NN, wherein the NN comprises a pair of NN layers and inter-neuron activation feed-forwards from a first of the pair of NN layers to a second of the NN layers, and the device is configured to compute activations of the neural network neurons of the second NN layers based on activations of the neural network neurons of the first NN layers by
forming a matrix X out of the activations of the neural network neurons of the first NN layers, and
computing s·W′*X wherein * denotes a matrix multiplication, W′ is a weight matrix of dimensions n×m with n and m∈ [symbol] , s is transposed vector of length n, and · denotes a column wise Hadamard multiplication between a matrix on the one side of · and a transposed vector on the other side ·.

24. Device of claim 23, configured to compute the matrix multiplication using n-bit fixed point arithmetic to yield a dot product and multiply the dot product with s using m-bit fixed point arithmetic with m>n.

25. Device of claim 23, wherein s is the result of an optimization of W′ in terms of higher compression for coding W′ and/or higher inference fidelity.

26. Device of claim 23, comprising a NN parametrizer configured to derive W′ from a NN representation, the NN parametrizer comprising an apparatus for deriving a NN parameter from a NN representation according to any preceding claims 43 to 62.

27. Device of claim 23, wherein the NN parametrizer is further configured to derive s from the NN representation with using different quantization parameter than compared to a NN parameter which relates to W′.

28. Method for generating a NN representation, comprising quantizing an NN parameter onto a quantized value by
determining a quantization parameter and a quantization value for the NN parameter so that from the quantization parameter, there is derivable
a multiplier based on a remainder of a division between a dividend derived by the quantization parameter and a divisor derived by an accuracy parameter and
a bit shift number based on a rounding of the quotient of the division,
so that the quantized value of the NN parameter corresponds to a product between the quantization value and a factor which depends on the multiplier, bit-shifted by a number of bits which depends on the bit shift number.

29. Method for deriving a NN parameter from a NN representation, comprising
deriving a quantization parameter from the NN representation,
deriving a quantization value from the NN representation, and
deriving, from the quantization parameter,
a multiplier based on a remainder of a division between a dividend derived by the quantization parameter and a divisor derived by a accuracy parameter and
a bit shift number based on a rounding of the quotient of the division,
wherein the NN parameter corresponds to a product between the quantization value and a factor which depends on the multiplier, bit-shifted by a number of bits which depends on the bit shift number.

30. Method for performing an inference using a NN, comprising computing an inference output based on a NN input using the NN, wherein the NN comprises a pair of NN layers and inter-neuron activation feed-forwards from a first of the pair of NN layers to a second of the NN layers, and the method comprises computing activations of the neural network neurons of the second NN layers based on activations of the neural network neurons of the first NN layers by
forming a matrix X out of the activations of the neural network neurons of the first NN layers, and
computing s·W′*X wherein * denotes a matrix multiplication, W′ is a weight matrix of dimensions n×m with n and m∈ [symbol] , s is transposed vector of length n, and · denotes a column wise Hadamard multiplication between a matrix the one side of · and a transposed vector on the other side ·.

31. Digital storage medium comprising digital data according to claim 2.

32. A non-transitory digital storage medium having a computer program stored thereon to perform the method for deriving a NN parameter from a NN representation, comprising
deriving a quantization parameter from the NN representation,
deriving a quantization value from the NN representation, and
deriving, from the quantization parameter,
a multiplier based on a remainder of a division between a dividend derived by the quantization parameter and a divisor derived by a accuracy parameter and
a bit shift number based on a rounding of the quotient of the division,
wherein the NN parameter corresponds to a product between the quantization value and a factor which depends on the multiplier, bit-shifted by a number of bits which depends on the bit shift number,
when said computer program is run by a computer

33. Data stream generated by an apparatus according to claim 1.
